(19) United States
(12) Patent Application Publication
(10) Pub. No.: US 2007/0143329 A1
(43) Pub. Date: Jun. 21, 2007

(54) System and method for analyzing communications using multi-dimensional hierarchical structures

(76) Inventor: Eric Arno Vigen, Laguna Hills, CA (US)

Correspondence Address: GREENBERG TRAURIG LLP, 2450 COLORADO AVENUE, SUITE 400E, SANTA MONICA, CA, 90404, US

(21) Appl. No.: 11/512,807

(22) Filed: Aug. 29, 2006

Related U.S. Application Data
(63) Continuation-in-part of application No. 11/303,304, filed on Dec. 16, 2005.

(51) Int. Cl. G06F 7/00

(52) U.S. Cl. 707/101

(57) ABSTRACT

A system and method is provided which processes communication into a useful multi-dimensional, hierarchical structure that illustrates visible multi-dimensional relationships between elements of the communication and also provides an understanding of the concepts underlying the communication. A communication is initially separated into its constituent elements. Queries to structured databases and novel relational tables are then performed to reference predetermined relationships between the communication elements and hierarchical categories, where information placements in the databases and tables are utilized to generate a hierarchical structure corresponding to the communication that provides a visual analysis and/or interpretation of the communication. By understanding the underlying concepts and tone of the communication, an automated communications analysis system is provided that allows prompt procedures, such as the grading and evaluation of writing, to be performed in an accurate manner.

### RELATED APPLICATIONS

This application is a continuation-in-part of U.S. application Ser. No. 11/303,304, entitled “System and Method for Analyzing Communications Using Multi-Dimensional Hierarchical Structures,” filed Dec. 16, 2005, the contents of which are hereby incorporated by reference in its entirety.

### BACKGROUND

This disclosure relates generally to the field of analyzing text and other communications and, more particularly, to a system and method for analyzing communication and its underlying believability, decision-making and persuasion processes using novel hierarchical structures.

There have been numerous attempts to utilize automated systems to analyze text or speech. For instance, systems exist which use a computer to translate text from one language into another language, where such systems typically use one-to-one mappings of words in one language to corresponding words in a second language without consideration of the context of the word. Unfortunately, it can be difficult to automatically translate text in one language to text in another language so that the meaning of the original text is accurately reflected in the translation. Furthermore, it is difficult to phrase the translated text correctly and comply with the grammar rules of the translation language.

There have been other attempts at evaluating writing using computerized techniques. For instance, word processing programs exist that include procedures for identifying particular writing errors, such as misspellings or subject-verb agreement problems. The usefulness of these approaches are limited in that they are based solely on grammar and parts of speech. Such approaches provide little feedback regarding a particular writing style being analyzed, which traditionally has been felt to be more subjective in nature. There have been some attempts at analyzing writing style by measuring coherence or the correlation between segments of text being evaluated. One such writing coherence analyzer, known as latent semantic analysis (LSA), uses a vector-based similarity calculations between text segments to measure relatedness. However, several drawbacks exist for these known systems of text coherence evaluation which simply calculate the similarity between adjacent sentences in a text and use the assumption that the chain of text coherence is essentially linear.

There is a need to develop a system and method to automatically evaluate and analyze text and other communications, wherein the analysis comprehends the meaning of the communications, wherein the analysis corresponds greatly with human-based scoring, wherein the analysis does not require voluminous sample data in order to complete the automatic evaluation, wherein a hierarchical structure is developed to accurately evaluate the communication and the hierarchical structure can be used to create various different types of outputs.

### SUMMARY

According to a feature of the disclosure, a system and method is provided which processes communication into a useful multi-dimensional, hierarchical structure capable of: 1) providing a visual interpretation and analysis of the communication to illustrate patterns in visual results, 2) allowing further processes to be performed on the hierarchical structure to identify weaknesses in the communication, 3) providing an analysis of the communication, such as grading of the communication and recommendations for improvement, and 4) allowing for the automated creation of a new or improved communication in any form and in any language by performing transformations of the hierarchical structure in reverse.

The hierarchical structure illustrates visible multi-dimensional relationships between elements of the communication and also provides an understanding of the concepts underlying the communication. By understanding the underlying concepts of the communication, an automated communications analysis can be provided that allows prompt grading processes previously only achievable using the subjective grading process of human proof-readers or complex computer programs requiring the preloading of a large number of human-graded pre-samples. The present improved communications analysis is performed by separating a communication into its constituent elements, at a level more detailed than a word alone or its part of speech, performing queries to structured databases and novel relational tables to reference predetermined relationships between the communication elements and hierarchical categories, and using such queries to create a hierarchical structure that provides a visual analysis and/or interpretation of the communication.

In one aspect, the present system and method analyzes communications by receiving a communication, forming computer readable text, parsing the text, analyzing the parsed text against a database containing hierarchical classification associations, creating a hierarchical structure (e.g., multi-dimensional array) representing the received communication, and analyzing the hierarchical structure to derive useful information. The hierarchical structure may include a plurality of levels of classifications and sub-classifications that represent the received communication and can be utilized to derive the useful information about the communication.

In another aspect, the hierarchical structure can be analyzed to determine the tone of the received communication or the depth of proper usage of certain elements in the received communication.

For purposes of summarizing the disclosure and the advantages achieved over the prior art, certain advantages of the disclosure have been described herein. Of course, it is to be understood that not necessarily all such advantages may be achieved in accordance with any particular embodiment of the disclosure. In fact, for certain usages and outputs, such as teaching young writers, the system output will be specifically restricted to one function or advantage at the expense of other functions to focus on training in one communications skill at a time. Thus, for example, those skilled in the art will recognize that the disclosure may be embodied or carried out in a manner that achieves or optimizes one advantage or group of advantages as taught herein without necessarily achieving other advantages as may be taught or suggested herein.

All of these embodiments are intended to be within the scope of the disclosure herein disclosed. These and other embodiments of the present disclosure will become readily apparent to those skilled in the art from the following detailed description of the preferred embodiments having reference to the attached figures, the disclosure not being limited to any particular preferred embodiment disclosed.

### DRAWINGS

The above-mentioned features and objects of the present disclosure will become more apparent with reference to the following description taken in conjunction with the accompanying drawings wherein like reference numerals denote like elements and in which:

FIG. 1 is a flow diagram of a method for analyzing communication in accordance with the present disclosure.

FIG. 2 is a representative hierarchical structure of the Process dimension versus the Situation dimension in accordance with the present disclosure.

FIG. 3 is a representative hierarchical structure of the Decision Matrix in the Value dimension in accordance with the present disclosure.

FIG. 4 is a representative hierarchical structure of the View dimension as applied to Decision Matrix in the Value dimension in accordance with the present disclosure.

FIG. 5 is a representative hierarchical structure of the sub-classifications of the Parties classification in the Situation dimension versus the Process dimension in accordance with the present disclosure.

FIG. 6 is a representative hierarchical structure for the sub-classifications of the “Higher Order Goals” in the Decision Matrix in accordance with the present disclosure.

FIG. 7 is another example of a representative hierarchical structure of the Decision Matrix in the Value dimension in accordance with the present disclosure.

FIG. 8 is another example of a representative hierarchical structure of the Process dimension versus the Situation dimension in accordance with the present disclosure.

FIGS. 9A-9E illustrate an example of the transformation of a received communication into a representative hierarchical structure of the Process dimension versus the Situation dimension in accordance with the present disclosure.

FIGS. 10A-10C illustrate an example of the transformation of a received communication into a representative hierarchical structure of the Decision Matrix in accordance with the present disclosure.

FIG. 11 is a block schematic diagram of an exemplary computer system that may be utilized for implementing the communications analysis in accordance with the present disclosure.

FIG. 12 is another block schematic diagram of an exemplary computer system that may be utilized for implementing the communications analysis in accordance with the present disclosure.

FIGS. 13A-13C, 14A-14B, 15A-15B, 16A-16B, 17A-17B, 18A-18B, 19A-19B and 20A-20B illustrate examples of the communications analysis performed and output in accordance with the present disclosure.

FIG. 21 illustrates examples of dictionary database entries for a number of words in accordance with a thesaurus aspect of the present disclosure.

FIGS. 22A-22C illustrate an example of the communications analysis performed and output in accordance with one embodiment of the present disclosure.

FIG. 23 illustrates a representative output showing a depth of usage in accordance with one embodiment of the present disclosure.

FIGS. 24A-24B and 25 illustrate representative outputs showing the tone of the communication in accordance with one embodiment of the present disclosure.

### DETAILED DESCRIPTION

The present disclosure teaches a novel system and method for analyzing communication by transforming such communication into a useful, multi-dimensional, hierarchical structure. Rather than relying solely on parts of speech and grammar as the means of analyzing communications as performed conventionally, the present method categorizes elements of communication into such hierarchical structures using novel classification hierarchies. These hierarchical structures provide a powerful communication analysis tool that can be used in various embodiments for many applications, including but not limited to, for example, objectively and accurately grading essays, providing recommendations for revising texts or for improving writing or speaking abilities, creating outlines that summarize the communication, documenting underlying decision making and persuasion processes, translating the communication and providing more sensitive thesaurus word recommendations.

For the purposes of this disclosure, the term hierarchical structure shall refer to an array, table, chart or index of at least k dimensions (k≧1), where each dimension consists of classification information relevant to organization, meaning, reference, or understanding of the communication. Each dimension of the hierarchical structure may include any number of classifications or categories and may further include subclassifications within certain classifications such that a hierarchical tier of information can be represented in each dimension.

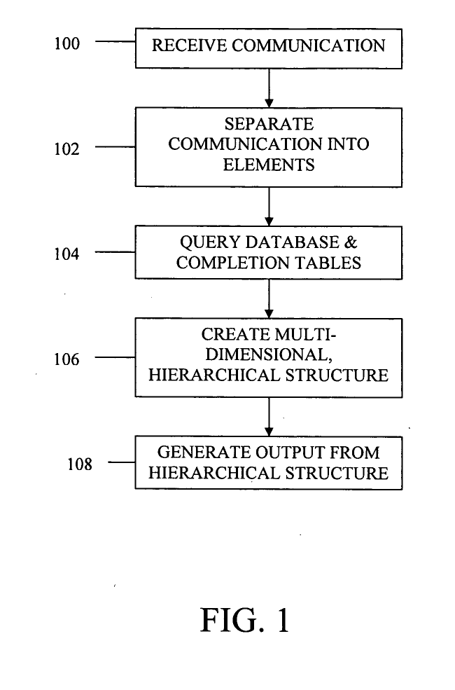

Referring now to FIG. 1, a flow diagram is illustrated for one embodiment of the method for analyzing communication by transforming such communication into a useful, multi-dimensional, hierarchical structure. At process block 100, a communication is received. The communication may be received in any form (e.g., text, handwriting, digital text files, audio files, audio streaming, live speech, visual communication, etc.) and in any language. Based upon the form in which the communication is received, some embodiments may require that the communication undergo an initial transformation to place the communication in a recognizable form capable of being parsed into the individual elements that make up the communication. For instance, a character recognition device may be utilized to convert written text or handwriting into a digital text files or a speech recognition device may be utilized to convert speech or audio files into digital text files as are known to those skilled in the art.

Each communication comprises a plurality of constituent elements, such as letters, words, punctuation, line breaks, paragraph breaks, page breaks, headings, text files, sound files and such. Each communication also includes at least one and likely many communication groups, such as words alone, phrases, sentences, paragraphs, passages, chapters and such.

After the received communication is placed into a recognizable and parsable form, the received communication is separated or parsed in process block 102 into individual communication elements, such as words, phrases or groups. Individual communication elements will be described in the various embodiments as words for ease in describing the present method, but it is understood that the communication elements may take any form consistent with the teachings herein. A database query is performed in process block 104 to retrieve hierarchical classification information contained therein for the parsed words from the received communication. In one embodiment, the database is a definition database containing stored words along with hierarchical classification information. The definition database comprises, in part, a lexicon of words including corresponding definitions, classification hierarchy elements and all of the various derivates of each word, such as plurals. Moreover, phrases, such as idioms, that convey meanings inconsistent with the definitions of each word of the phrase alone are included in the database.

Words stored in the definition database may have multiple definitions if reviewed only as a search for the word alone. However, the database will have a unique identifier for each word in combination with relative order and hierarchical classification of communications elements from surrounding words. The communication elements in the dictionary database have a primary hierarchical reference that follows from the top of the hierarchy to one specific primary subcategory with additional restrictive and reference links from other dimensions. The best match may be determined by examining the hierarchical references and relative communications order of the nearby communication elements. The retrieval process in process block 104 includes selection criteria that extend beyond merely looking up the word itself and include an examination of the surrounding communication elements according to search algorithms to assist in selecting the appropriate information to retrieve. The retrieval process may utilize a word plus its placement in relation to certain other hierarchical placements of communication elements surrounding it to determine the appropriate information to retrieve. Thus, for each word in a communications group, one or more information placements indicating a position in the hierarchical structures are retrieved, where each information placement may possess a value for priority based upon data in the dictionary database, the order of receipt and/or its relationship to surrounding words received. In an embodiment, entries with multiple classification hierarchy elements may have priority information embedded, which indicate the relative importance of the classification hierarchy element as related to the word, especially where multiple categories within the same classification hierarchy apply.

The database should have a primary information placement for the communications elements stored therein. In addition, the database may have number, gender, tense, voice or similar grammatical fields or formats for additional matching or may be two items with number and gender as one of the data fields.

The information retrieved from the dictionary database and completion tables is then used to create the hierarchical structure or (k-dimensional array) in process block 106. Classification hierarchy categorical information directs each element of the communication (i.e., parsed words) to be placed into the hierarchical structure comprised of any number of dimensions, each dimension corresponding to a classification hierarchy. One or more classification hierarchies are contemplated, where each classification hierarchy is defined as a dimension in a k-dimensional array, which may be used to produce useful output. The k-dimensional array exists in multiple dimensions defined by the various classification hierarchy tiers, as will be described in detail below. Each classification hierarchy tier comprises categorical and sub-categorical elements, where each sub-categorical element may be further divided into yet additional sub-categorical elements which may also in turn be further divided. As such, the classification hierarchy tier may contain any possible number of levels of categorical and sub-categorical elements. The hierarchical structure may comprise one or more k-dimensional arrays defined by the various classification hierarchy tiers or, alternatively, may comprise a single multi-dimensional array storing all of the information in a plurality of dimensions with each dimension representing a respective tier of a classification hierarchy.

The database retrieval creates for each word one or more information placements in the hierarchical structure. The method continues placing words into the hierarchical structure according to algorithms using order, surrounding elements (other words, punctuation) until a complete hierarchical structure (i.e., table of information) is completed for a given grouping of communication elements, such as for each sentence, paragraph, chapter, etc.

Once the hierarchical structure has been completed, the hierarchical structure can be utilized to generate a desired output in process block 110. For instance, an output algorithm can evaluate various relationships between the word placements in the hierarchical structure in order to automatically elucidate the meanings intended in the communication. Thus, the hierarchical structure exists as an organizer, where definitions of instances of words signify locations in at least one k-dimensional array where the word exists. Information can thereby be derived based on analysis of patterns, duplicative information, ratios, order, or the absence of data in the k-dimensional arrays.

The hierarchical structure can be utilized to output: 1) various presentations of the communication showing subsets of these dimensions or cross-dimensions in tables, charts and reports; 2) a visual chart/picture of certain elements of communication traditionally invisible from the words alone, such as motivation, theme, process, tone and/or proficiency; 3) a structure documenting the communication on a more in-depth level than just the word received; 4) identification of communications weaknesses, missing information and critical thinking issues based upon algorithms applied to the structured information; 5) recommendations for improvements; 6) grading valuations and commendations; 7) communications improvements such as revised text with improved wording; and/or 8) a new structure for a dictionary and thesaurus based upon that structure.

In one embodiment, the hierarchical structure can also be used as a building block in reverse to build new communications in other languages or dialects based upon a completed hierarchical structure without having to start from an existing communication and having to perform a two-way decode and encode combination to translate communications from one language or dialect to other languages or dialects. Thus, the present method of analyzing communication can more accurately output useful information, such as grades or translations, with improved fidelity over current mechanical implementations seeking to accomplish similar tasks.

The various hierarchical structures representing groupings of communication can be used in combination or by using subsets thereof to analyze the communication by using placements within the structures, ratios of the subsets or by relating the order of the subsets to indicate the specific flow of information within the communication. The combinations of the hierarchical structures can be used to show the flow, order, organization, effectiveness, tone and depth of proper usage of elements of the communication. Those structures with backwards movements, with repeat placements, with extra placements, with missing placements or other undesirable placements each can be used to generate 1) grade valuation changes, 2) recommendations, comments and/or commendations and 3) improved or corrected communications.

The present communications analysis method uses a classification hierarchy that allows the meaning of the ideas conveyed in communication to be elucidated from the generated hierarchical structures. In this manner, a computer or machine could create and analyze the hierarchical structures to determine the meaning of the received communication in a manner equivalent to the subjective analysis provided by human proof-readers. Thus, the particular classification hierarchies or dimensions are selected to allow the meaning of the communication to be determined.

In one embodiment, the classification hierarchies include at least one of the following classifications or dimensions: Situation, Process, Value and View. However, it is understood that other similar classifications or dimensions could be utilized that elicit the meaning of the communication. The Value and View dimensions are closely related and can potentially be merged into a single dimension in another embodiment, which might call the combined Value and View dimensions according to another name, such as the Logical dimension, for example. In yet another embodiment, the use of grammar rules and parts of speech as independent categories may be used as an additional classification hierarchy in combination with the Situation, Process, Value, and View dimensions. Each dimension may contain sub-classifications, and each sub-classification may comprise sub-sub-classifications and so forth to create desired hierarchies under each dimension as required to elicit the meaning of a communication to produce useful output.

Situation Dimension

In one embodiment, one of the classification hierarchies includes the Situation dimension which classifies words based on situation data: such as party, location, time, resources, abilities, beliefs, and goals. These situation criteria roughly correspond to the questions of who, where, when, what, how and why, respectively, in a given communication. Both beliefs and goals relate to the how question, albeit from different perspectives. Within the Situation dimension, some or all Situation classifications have sub-classifications. For example, in one embodiment, the parties classification sub-classifies into perspective, actors, and recipients. In another embodiment, the location classification sub-classifies into length, width, height, proximity, and physical location among others. These further sub-classifications under each classification create the opportunity for useful sorting when applying output generation procedures.

Process Dimension

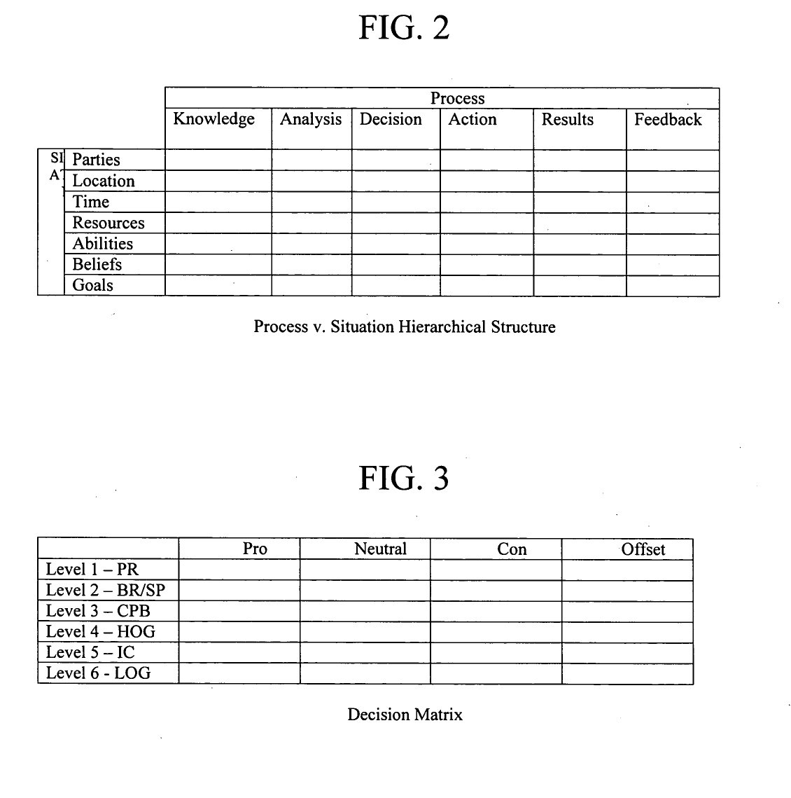

In one embodiment, one of the classification hierarchies includes the Process dimension which considers the process reflected in a communication. The Process dimension includes at least one of the following hierarchical sub-classifications: knowledge, analysis, decision, action, results, and feedback (KADARF). Another embodiment of the present communications analysis method also contemplates using a smaller set of process categories, such as the knowledge, analysis, action, and results categories. The sub-classifications of Process dimension relate to general points in a process. The knowledge sub-classifications relates to facts necessary to complete the process. The results and feedback sub-classifications related to the outcome of a process. Analysis, decision, and action are sub-classifications relating to steps taken during a process. Referring to FIG. 2, a hierarchical structure or array of the process dimension versus the situation dimension is illustrated.

In one aspect, the analysis sub-classification can be divided between criteria-based placements (analytical or deductive) and assessment-based placements (intuitive or inductive). In one aspect, the decision sub-classification can be divided between placements preferring either 1) being decisive or 2) keeping open options. In one aspect, the action sub-classification for interaction methods can be divided into the further sub-classifications: force, alone/avoid, compete and trade/team. In one aspect, the results sub-classification can be divided into the further sub-classifications: fun, security, support and growth placements. In one aspect, the feedback sub-classification can be divided into the further sub-classifications: emotional feelings (e.g., by analyzing the results sub-classification for the personal value) and deconstructive thinking (e.g., by analyzing the prior steps and their linkage for effectiveness).

Value Dimension

In one embodiment, one of the classification hierarchies includes the Value dimension which defines motivations reflected in a communication. The Value dimension includes a Decision Matrix as the fundamental organizational hierarchical structure, as illustrated in FIG. 3. The illustrated structure connects the 1) positive or negative Value concept by the columns with 2) the relative priority Value concept by the rows and 3) the truth Value concept by the communicator's choice to communicate such or the user's choice to place the item in the structure. The Value dimension includes the following sub-classifications of the Decision Matrix: practical reality (PR) (those items outside the control to change in this situation), basic respect and self-protection (BR/SP) (those items that harm other parties), core personal beliefs (CPB) (the actions that the perspective party believes creates results powerfully and consistently), higher order goals (HOG) (the highest ranking Results sought by the perspective party), interaction commitments (IC) (agreements, teams), and lower order goals (LOG) (lower ranking beliefs, goals, interactions). While one embodiment uses these six sub-classifications in the above, it is understood that other sub-classifications or a different order of categories is contemplated by the present communications analysis method.

Depending on the context, Value dimension subcategories differentiate by either truth and completeness or by positive and negative values. The subcategories of the Value dimension can be weighted differently. In one embodiment, values associated with practical reality are considered as being of greater weight than values associated with basic respect and self-protection, which are weighted more than core personal beliefs, and so forth down the progression in the Decision Matrix. Thus, all thing being equal, a value of +1 assigned to all Value classification hierarchy categories might practically be +6 for the practical reality subcategory, +5 for the basic respect and self-protection subcategory, and only a +1 for the lower order goals subcategory.

These weightings or rankings as well as the concepts of truth and/or completeness are often based on a subjective value based on perception and perspective. In one embodiment, the communications analysis method measures the communicator's subjective values by this placements and ranking in a novel way. This provides a method for transforming subjective analysis into workable components in the Decision Matrix and related structures. The subjective values of the communicator can be determined from this structure and even compared with the subjective values of others or with potential values standards.

An aspect of the Value dimension that may be considered in one embodiment is the bias related perspective inherent in a communication. For example, winning the lottery is perceived to be positive for the winner; it might also be perceived to be negative for some losers or irrelevant (neutral) to those who do not play the lottery. In one embodiment, the communications analysis method utilizes an output table including a comparison of the Value dimension selected for one party with additional subclassification rankings below the six Decision Matrix levels (that is, a personalized list of Practical Reality, Core Personal Beliefs, Higher Order Goals, etc.). This output table provides a map for items such as motivation or the persuasion of believability in communications. This table can be expanded in the View dimension for the particular party and the View dimension of a different party for the same Value elements. This table could then be utilized to generate visual presentation, predictions, recommendations, grading valuations and even propose further new or improved communications based upon algorithms applied to the table. Thus, values in the Decision Matrix may be reflected differently based on the perspective of the communicator and how they are processed by the receiver. Values and other subjective elements of communications as well as the decision making and persuasive processes can thus be analyzed in novel ways. The tables that process these analyses are a novel way to transform those concepts into new functional hierarchical structures. The generated output can provide recommendations that change the way the idea is communicated to fit the patterns of the recipient using the Decision Matrix structure and personalized subclassifications.

Similarly, different perspectives may account for variations in the degree to which truth and completeness are viewed in the communication, such as by providing grading values and recommendations about believability. The communications word choice, order and other communication elements express or implicitly derived through algorithms and completion tables connect to these personalized decision matrix tables. These tables can reference a completion table for missing communications elements or the system's novel structure for a thesaurus for better words that say all the same communications elements with fewer words or with words that have improved process flow or persuasive effect. These tables are a measurement of subjective values, truth concepts and completeness concepts. Consequently, the Value dimension considers the communicator's bias by using Pros and Cons.

In another embodiment, “Neutral” and “Offset” categories may be added to provide still further variations in the degree to which truth and completeness are viewed in the communication. These additional fields can be used with respect to certain functions and for the presentation of certain concepts. For example, the reversal of the Practical Reality Con “cannot” is not the Practical Reality Pro “must,” but a practical reality neutral at the practical reality priority “neither required to happen nor impossible to happen.” These extra fields are omitted when not relevant to the particular use.

View Dimension

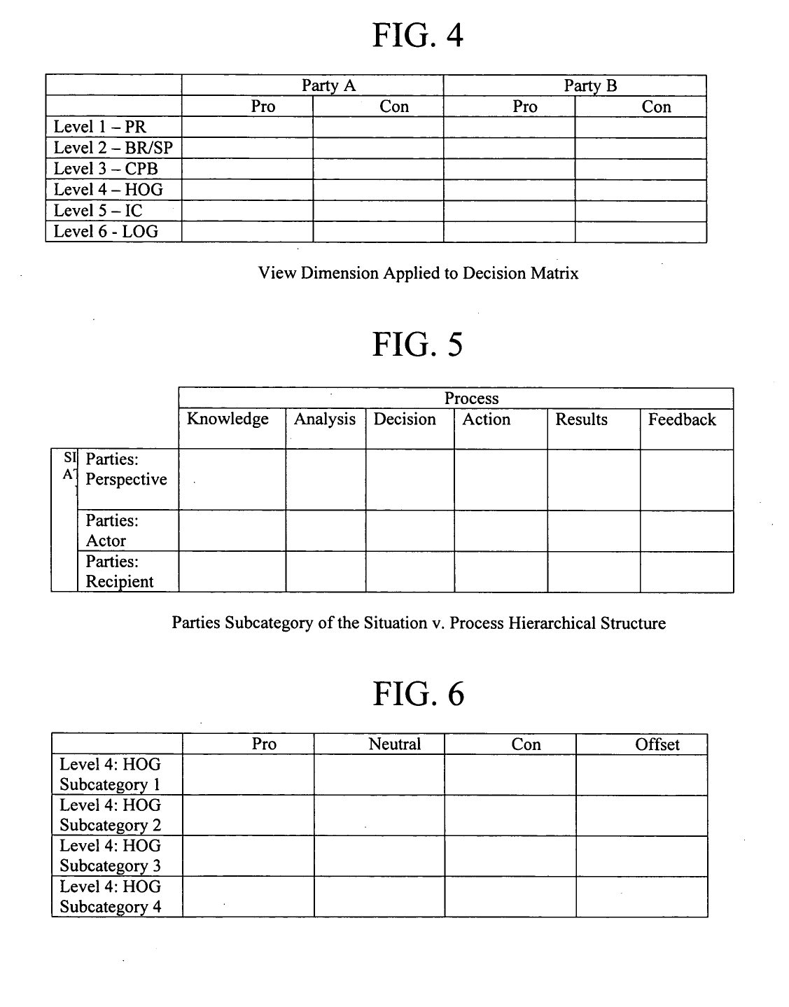

In one embodiment, one of the classification hierarchies includes the View dimension which considers the logical implications inherent in communication. The View dimension essentially captures various perspectives of the communicator and the communicatees. The View dimension uses informational comparisons, orderings, and variances to classify relative values based on perspective. A hierarchical structure array of the View dimension applied to the Decision Matrix is illustrated in FIG. 4.

In another embodiment, in addition to the four classification hierarchies previously discussed, the present communications analysis method may further include additional classification hierarchies. One such classification hierarchy would consider, in combination with the other classification hierarchies, a word's part of speech. Analysis of a word's part of speech in conjunction with other classification hierarchies allows fine tuning of the correct analysis of a word's use in a sentence or paragraph. Another such classification hierarchy would consider the order of ideas occurring in a communication. Analysis of the order in which classification hierarchy categories occur provides insight as to the coherence of the communication's flow. For example, an essay that discusses the outcome of a party's action before it discusses the facts surrounding the action may present the ideas out of order. Thus, including a classification hierarchy that tracks the order in which ideas are presented in a communication can further fine tune the analysis of the communication.

As described above, each of the classifications in the various dimensions can also have sub-classifications, wherein hierarchical structures can be generated for the sub-classifications as well in order to provide a deeper layer of understanding of the communication. For example, referring to FIG. 5, a hierarchical structure of the sub-sub-classifications of the Parties sub-classification in the Situation dimension versus the Process is illustrated. It is also contemplated that the sub-classifications can be modifiable, such that different sub-classifications can be selected for different purposes. For example, referring to FIG. 6, a hierarchical structure for the sub-classifications of the “Higher Order Goals” in the Decision Matrix is illustrated with several unnamed subcategories that can selected as appropriate for a given analysis.

The hierarchical structures described herein are populated with information placements for the words in the communication that are being parsed and analyzed. As described above, there are situations where a word will have different meanings and different information placements in the hierarchical structures depending upon the intended meaning of a word in a particular context. For example, a dictionary comprises the word ‘throw’ in at least four instances, comprising at least four distinct definitions of classification hierarchy elements. Thus, a communication may use ‘throw’ as follows: ‘throw up,’ ‘throw a party,’ ‘throw a bash,’ ‘throw a fit,’ or ‘throw a baseball.’ These uses roughly correspond to the following categories: an idiom (‘throw up’), a social event (‘throw’ plus ‘party,’ ‘bash,’ or ‘a ball’), a movement of a physical object event (‘throw a baseball’ or ‘a ball’), and behavior event (‘throw a fit’). To determine which meaning is associated with the word ‘throw,’ contextual clues are used to select the instance of ‘throw’ in the dictionary that gives the definition of classification hierarchy elements that matches the intended meaning of ‘throw’ in the communication. Accomplishing this task requires evaluation of the classification hierarchy elements of the words nearby to ‘throw.’ This novel approach selects the correct solution for multiple combinations of communications with only one database record. One record retrieves the specific communication elements for ‘throw a bash’ or ‘throw a party.’ Of course, some definitions may be very specific. If the nearby word immediately to the right is ‘up,’ regardless of ‘up's’ classification hierarchy elements, then the classification hierarchy elements of ‘throw’ associated with the act of vomiting are selected. The search would start at the deepest hierarchy level and continue up until a single match occurs. The communications analysis system and method provides a means for performing such a search.

However, the instances of ‘throw’ involving the social event, physical event, and behavioral event must be evaluated on the basis of the classification hierarchy elements of the nearby words. This principle is most evident in the social event example; as exemplified, three words, ‘party,’ ‘bash,’ or ‘a ball,’ can be used to convey the same idea, which is to have a party. Thus, rather than permute all of the possible combinations of words that can be associated with the word ‘throw’ to indicate the idea of having a party such as the words ‘party,’ ‘bash,’ ‘a ball,’ the present disclosure looks to the classification hierarchy elements of the nearby words to determine the context of ‘throw.’ Here, an embodiment could classify the words ‘party,’ ‘bash,’ and ‘ball’ as “events” in hierarchy of “situation” words further restricted by “with more than one parties. Similarly, the identification of ‘throw a baseball’ would be unique from the database because the surrounding word in the object position is a physical resource word.

As exemplified in this example, however, the word ‘ball’ when searched alone can signify both an event, a party, and a physical resource (e.g., a baseball. However, the communications analysis method envisions that ‘ball’ would be first determined between a situation as a whole “event” and a physical “resource” by its prior unique search definition of surrounding communication elements, then the method would return the proper definition of “throw a ball” between event and physical object. Because the system derives a unique definition of ‘ball,’ the ambiguity of ‘throw’ disappears or is resolved. That is, when such an ambiguity exists, additional nearby words are examined until the ambiguity is resolved. Consequently, by using classification hierarchy elements of surrounding words, the correct instance of a word in the dictionary is selected, making the present disclosure a powerful tool by automatically or mechanically deriving the meaning intended in the communication.

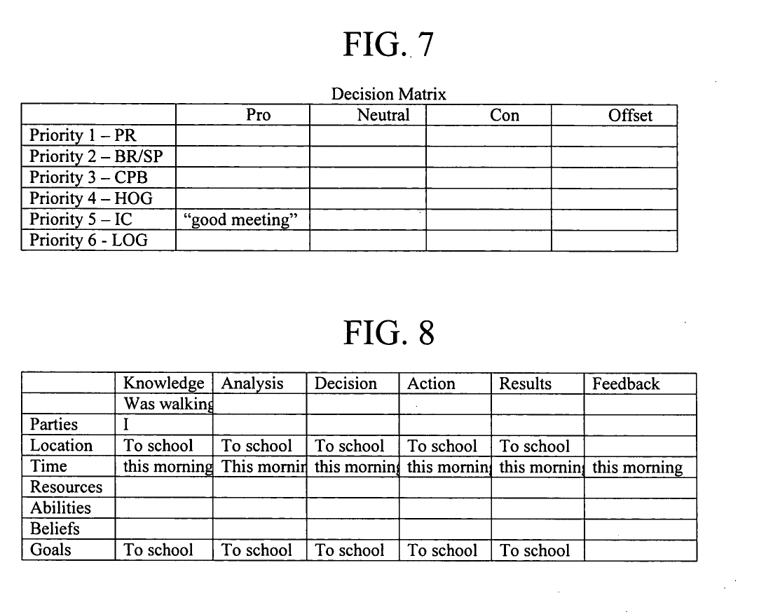

When transforming the received communication elements into the respective hierarchical structures, one embodiment of the present method utilizes guidelines that analyze the qualities of sets of words together in order to determine their proper placement in the hierarchical structures. For example, when transforming the phrase “good meeting” into the Decision Matrix hierarchical structure, the word “good” alone indicates that the item (situation and process) referenced is a Pro in the Analysis subset of the Decision Matrix. However, “good” by itself does not indicate which priority level in the Decision Matrix to place the term. The word “meeting” refers to an Interaction Commitment, thus a complete placement of the phrase “good meeting” is accomplished using the combined qualities of the words as illustrated in FIG. 7. Further, additional words might create a placement change algorithm such that, for example, the phrase “not a good meeting” has the placement of “good meeting” with the positive or negative concept reversed.

In another embodiment, the communications analysis method may employ guidelines which automatically fill in locations in the hierarchical structures unless other specific communication elements dictate that other information placements should be placed in those respective locations in the hierarchical structure. For example, information placements can be populated in the KADARF Process hierarchical structure to the right to the point decided by the clause creating the hierarchical structure. Referring to the example illustrated in FIG. 8, the phrase “I was walking to school this morning” could be transformed with the clause “to school” being populated through the Process from the Knowledge sub-classification to the Results sub-classification for various Situation sub-classifications.

An embodiment also includes completion tables or relational tables, which are able to add missing, and often necessary, classification hierarchy category information implied in a communication. The completion tables may either be stored together or separately from the dictionary database. Completion tables are implemented to supply missing information into the hierarchical structure and decision algorithm process. Missing information may include information that must populate related or connected classification hierarchy categories and may also constitute information implied in the communication. For example, in a sentence that reads “This is good,” the sentence implies a subject represented by the word ‘this.’ A completion table may be implemented to discover and populate the hierarchical structure with the word referred to by the word ‘this.’

For example, in a communication where the listener is identified as the Actor (a Situation party that performs the action), the Knowledge sentence, “It's cold outside,” can be matched in the completion table database to the following selection criteria—1) the party receiving the communication is an Actor 2) communicating a Knowledge process step 3) including a Situation ability of an energy word 4) with a value outside normal (cold, freezing, hot, etc.) and 5) the Situation location is changing (e.g., the location is different from the Knowledge step to the Results step). The completion table would then know that one sentence actually translates to three sentences with a complete Knowledge step, Analysis step and Decision step. The analysis being, “The [cold] might create a negative value to your health abilities.” The decision communications step inferred being, “[You must first or please] provide yourself protection (a positive to Basic Respect/Self-Protection) from the [cold].” The positive to Self-Protection Value dimension being the second most powerful driver of Decisions. Each of those elements occurs within the standard hierarchy of the system and can be determined from prior communications elements (or a decision making direct analysis by other means). Further, those are each one of the communication elements that are not at the word level, but at the communication more detailed elements level in the system's dictionary database and hierarchy defined in this system.

This completion in the above-described example would be insert in the missing Analysis and Decision steps in a different combination of search/selection criteria differently. If the party speaking “It is cold” is now the Actor from the communication of the other party, who had questioned, “Do you want to come out and play?,” then the completion algorithm would find a different matching completion table where the Decision step is different. The Decision step predicted by the system may be “I will not move to [outside].” Again, each component can be mapped to the combination of the various dimensions and viewed with various combination reports in this system. Both the completion table and the generated output use elements from all of the dimensions of the system in combination: process KADARF steps, situation framework criteria, negative and hierarchical Decision Matrix values. The system uses procedures that follow clear priorities and order as defined in the system to translate not just the meaning of what is communicated, but also to translate the unspoken, inferred elements of the communication.

Further, the system may even go on to make determinations including algorithms that use one or both party's personal priorities as built for previous knowledge about that party. Such knowledge can be acquired by inference from communications or by direct input or questionnaire. The system can predict the positive Decision to move to the likely or probably Action. The use of the Decision Matrix creates concrete factors used in the calculation of that likelihood, where that determination comes from the expanded Value dimension maintained for each party. This view is a database utilizing the View restricted to that party or some View grouping to which that party is a member. In such, the communications system expands to provide decision making predictions, evaluations, and recommendations and can even create further communications geared to more effective persuasion as warranted by the use of algorithms on the combination of those elements.

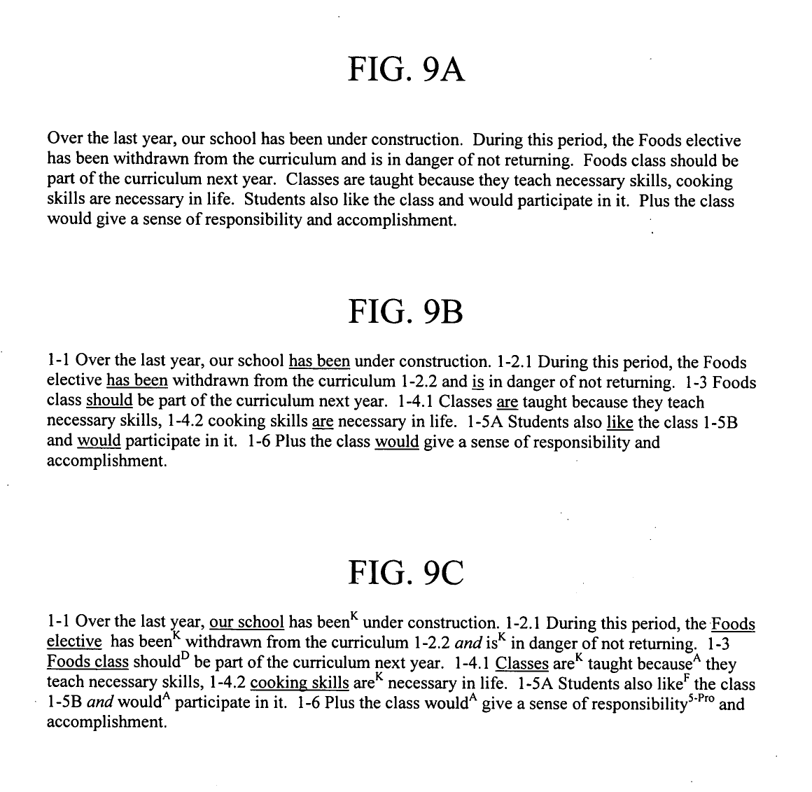

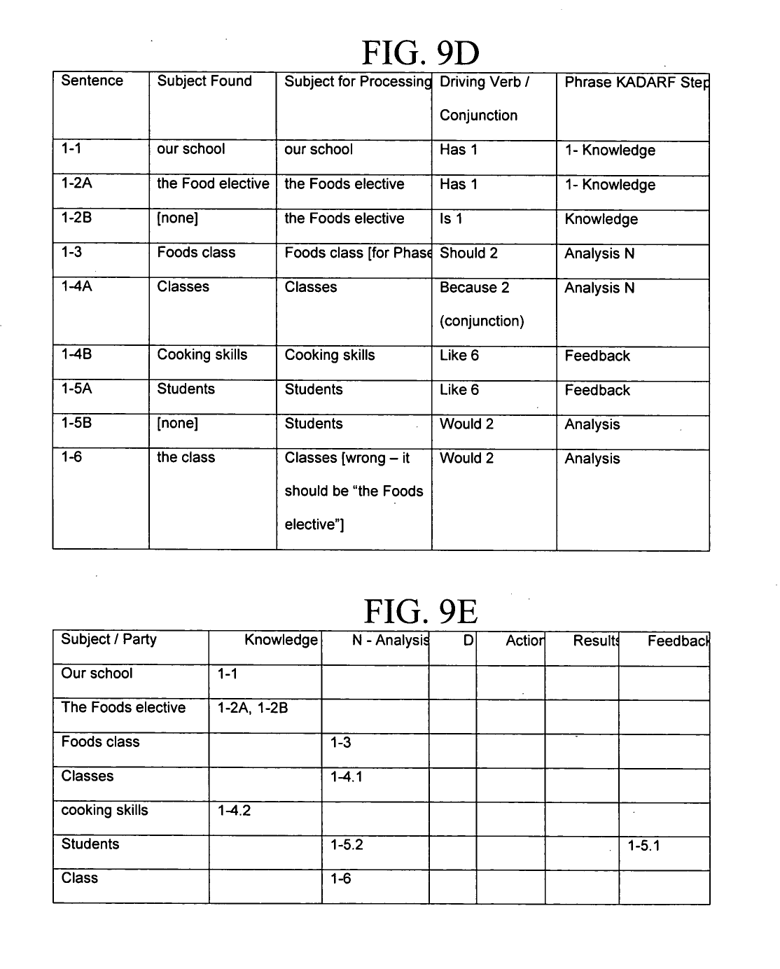

Referring now to FIGS. 9A-9E, one exemplary teaching of the present communications analysis method is set forth for the purposes of illustrating how the KADARF procedures are implemented to transform a communication into a hierarchical structure in one specific example; however, the communications analysis method is not intended to be limited solely to this example. In this exemplary embodiment, the communications analysis method performs the actions of identifying phrases in a received communication to be transformed and the respective main verb in such phrases, identifying the appropriate KADARF step, identifying the subject/party, creating an intermediate paragraph table, creating the hierarchical structure, and creating the analysis recommendations.

A sample received text communication is illustrated in FIG. 9A. The step of identifying the phrases and respective main verbs in the text communication includes a number of actions. Sentences are initially broken up by periods, conjunctions and commas. The sentences are identified by each period. At the start of each paragraph and after each period, each phrase is number sequentially by paragraph-sentence. If there is a comma or conjunction (using just Knowledge conjunctions not Analysis conjunctions), then it is determined if a verb exists (only in the simple present singular and plural and simple past format). A participle (-en with exceptions) or gerund (-ing) format is preferably not used for this determination. If there is no verb between commas, conjunctions and period, that section is determined to not be a verb phrase. If there are verbs in one or more sections of that sentence, then each section is numbered with a paragraph, sentence and section identifier, such as Para#-Sent#A, Para#-Sent#B and so on (1-1A, 1-1B and so on). These identifiers are placed just after the comma or just before the conjunction appropriately. This division is then used as the basic unit for paragraph mapping functions.

FIG. 9B illustrates how the phrases and respective main verbs would be identified for the textual paragraph of FIG. 9A with the main verbs being underlined and the identifiers labeled. In sentences 1-1 and 1-3, there are no commas or conjunctions. In sentence 1-2, the “,” after period is ignored because no main verb exists within that segment. The conjunction “and” does create another section because it includes a main verb “has” before and a main verb “is” after, which makes both sections distinct verb phrases. In sentence 14, the conjunction “and” does create another section because there is a main verb “are” before it and a main verb “are” after it, which makes both sections distinct verb phrases. In sentence 1-5, the conjunction “and” creates another section because there is a main verb “like” before it and a main verb “would” after it, which makes both sections distinct verb phrases. Finally, in sentence 1-6, the conjunction “and” does not create another section because there is no main verb after it before the next period, which keeps this sentence as a single verb phrase.

The KADARF driving verb or conjunction is next identified for each verb phrase. That is, analysis conjunctions override verbs for placement even though the primary hierarchical communication element of a verb might be another KADARF step. That is, “If I throw the ball, . . . ” is not an Action, it is Analysis because of the conjunction, even though ‘throw’ has an Action primary KADARF communications element in the word database. The entire placement process follows a series of steps. First, if there is an Analysis conjunction, the KADARF step is Analysis. Second, if no conjunction exists, a placement of verb first (as in the imperative case) places all the communication elements in that verb phrase (sentence) as a Decision. Third, if a Knowledge verb is found but the subject or object has a Feedback secondary communication element, the verb phrase is Feedback. Certain words, such as in “That was a stupid answer,” override the first verb for KADARF placement of the entire verb phrase. Finally, if none of those overrides are present, the first verb found provides its KADARF step as the KADARF step for this verb phrase (only in the simple present singular, plural or simple past format {a participle (/-en) or gerung (-ing) format does not count for this determination). For example, “I can run” is Knowledge by the first verb. The “can” drives the verb phrase placement based upon its KADARF step primary communication element lookup for the database. “I will run” is a Decision by the first verb “will” KADARF step Decision primary communication element lookup for the database. The final steps handle “helping words” and tenses that are complex in existing grammar programs in a novel method. It replaces those tables with one rule and database look-up into the hierarchical table used for that and other purposes.

The subject is then identified depending on a set of rules for each verb phrase. In this exemplary embodiment, this involves a three-step process of 1) identifying when specifics words come before the KADARF driving verb, 2) eliminating the Knowledge or Analysis conjunctions, 3) applying further guidelines when no words exist before the KADARF-driving verb: a) at the beginning of a sentence by filling in the Imperative [You] as the subject (e.g., “[You] Get out of the way”), b) as a second verb phrase in a sentence that uses the same subject as the previous verb phrase, and 4) modifying long subject phrases in two ways: a) pronouns follow a same-as-the-previous subject guideline, and b) same words (excluding articles like “the”) follow the same-as-the-previous subject guideline. The subject is essentially determined in two stages: 1) the subject words are segments looking at the text and 2) the subject is checked for matches already existing in the created table.

FIG. 9C illustrates how the subjects would be identified for the textual paragraph of FIG. 9A with the subject being underlined and the KADARF process verb identifiers labeled. In sentence 1-1, the “over the last year,” is ignored because it is a clause within a period, but without a KADARF driving verb. Therefore, only the “our school” before the verb is the subject. In section 1-2A, the “During this period,” is ignored because it is a clause within a period without a KADARF driving verb. Therefore, only the “our school” before the verb is the subject. In section 1-2B, the “and” is ignored because that is a Knowledge Validation conjunction and, after that, because there is no word before verb and this is a “B” clause, the subject is “the Foods elective” from the previous verb phrase. In section 1-3, “foods class” is the word before the verb and is the subject. However, the table of existing subjects already has one that says “the Foods elective,” since a word (excluding the list of articles “the”) within certain relative positions in consideration of other communications elements algorithms is the same. In section 1-4A, “classes” is the word before the verb and does not match “the Foods elective” so this is a new subject. In section 1-4B, “Cooking skills” is the word group before the verb. In section 1-5A, “Students” is the word group before the verb. In section 1-5B, because there is no word before verb and this is a “B” clause, the subject is “Students” from the previous verb phrase. In section 1-6, the “plus” is ignored because that is a Knowledge Validation conjunction and, after that, “the class” is the words before the KADARF-driving verb. However, that word class is included in a previous subject-for-processing so this joins that one and the subject is “Classes.” The information identified above from the communication of FIG. 9A would then be placed into the table illustrated in FIG. 9D.

From the table of FIG. 9D, a hierarchical structure representing the Parties subcategory of the Situation versus the Process dimensions are created with the identifying placements inserted into the hierarchical structure, as illustrated in FIG. 9E. It is understood that the hierarchical structure could alternatively be created without requiring the intermediately-formed table of FIG. 9D. Grading, commendations and recommendations can then be generated by analyzing how each verb phrase moves through the hierarchical structure.

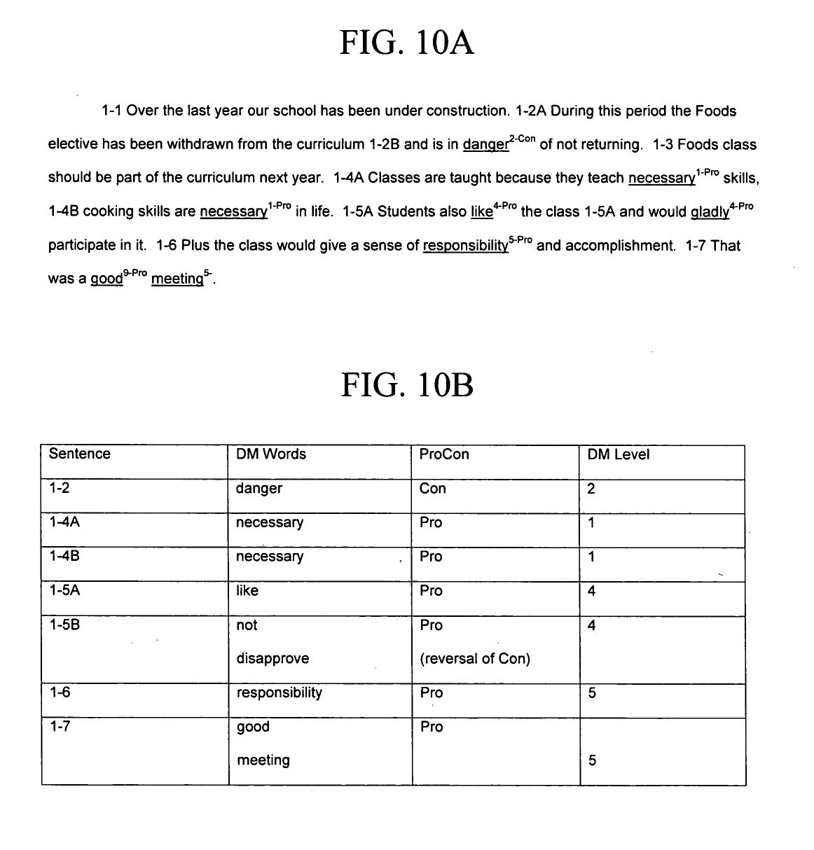

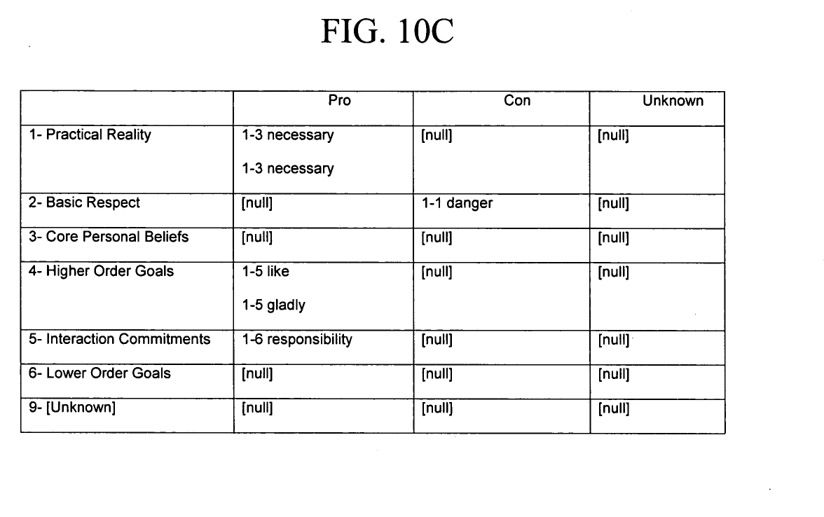

Referring now to FIGS. 10A-10C, one exemplary teaching of the present communications analysis method is set forth for the purposes of illustrating how the Decision Matrix procedures are implemented in one specific example; however, the communications analysis method is not intended to be limited in any manner to this example. The Decision Matrix shows when and how communications elements document the relative priorities that drive the real life (or fictional) related activities. The Decision Matrix is designed to show 1) the relative strength of values argued, 2) instances when the arguments are favorable or unfavorable and 3) the strength or weakness of the communications of those values and 4) the thinking process that underlies the parties (or character's) decision.

The Decision Matrix compares the goal of the motivation or conflict portion of any passage to determine:

1. Are factors clearly placed as Pros and Cons at distinct levels based upon the grid created?

2. Are the Pros higher, so that the Pros outweigh the Cons to drive the decision maker? Or are the Cons higher to describe that the situation rests in conflict at this stage?

3. If a comparison paragraph, does the communication limit the comparison to two clear levels, and is Pro or Con higher?

4. For support paragraphs, does the communication stick with all support sentences that describe the same?

5. If an Offset paragraph, does the communication go back to describe the Action and Results so that they offset properly?

6. What is the pattern, number of placements and relative positions of those placements?

7. What order does the communication use to fill in that grid?

For the sample received communication illustrated in FIG. 9A, the communication is analyzed similar to the previous example to identify the Decision Matrix classification identifiers, where the communication would be broken down to appear as shown in FIG. 10A with the Decision Matrix words being underlined. These identifications would then be converted into the table illustrated in FIG. 10B, which in turn would be converted into the Decision Matrix hierarchical structure illustrated in FIG. 10C. From the Decision Matrix hierarchical structure, grading, commendations and recommendations can then be generated by analyzing how the Pros and Cons relate to each other using the rules set forth above.

For example, if a Decision Matrix includes all Cons, a Recommendation may be output stating: “This paragraph paints a very negative picture. That might be important if fear is the motivation to action. However, if you want to show how most people think, you might consider if you can present words that also show why the Actor continues in the face of this negative.” Contrarily, by example, if a Decision Matrix includes all Pros, a Comment may be output stating: “This paragraph paints a very positive picture. While this is great for sales literature or a evidence support paragraph, the paragraph lacks any conflict. If this is a narrative, then most people move forward with decision based upon a balancing of Pros and Cons.”

The Decision Matrix provides a review of the values from the perspective of the writer's chosen party within each paragraph and for passages overall. The words people use describe the level of importance which they apply to each item and a positive/negative connotation. The communications analysis method derives this information from the dictionary database. For a Decision Matrix analysis in one embodiment, only the Value ‘communication elements’ are extracted from the dictionary database and placed into a new table for the segment of communication (e.g., a paragraph. The retrieved communication elements plus the algorithms and completion tables described herein are used to handle issues such as double negatives or phrases like “not a bad idea.”

Decision Matrix Output Patterns

### EXAMPLE 1

A superior Analysis paragraph would describe the conflict, and it would have one placement at each of two levels. For example, the paragraph:

“I am tired. I cannot go out tonight even though I want to.”

would have placements as shown in the following table:

| | Pro | Con | Offset | Unknown |
|---|---|---|---|---|
| Practical Reality | | 1.1 cannot | | |
| Basic Respect - | | | | |
| Self-Protection | | | | |
| Core Personal | | | | |
| Beliefs | | | | |
| Higher Order | | | | |
| Goals | | | | |
| Interaction | | | | |
| Commitments | | | | |
| Lower Order | 1.4 want to | | | |
| Goals | | | | |
| Unknown | | | | |

A paragraph with those only those two Decision Matrix communication elements creates a clear communication of the party's analysis and decision.

### EXAMPLE 2

A superior Support paragraph would have a series of placements from each verb phrase in the same location. For example, the paragraph:

“1 Protecting the environment is important. 2A It saves lives and 2B conserves resources.”

would have placements as shown in the following table:

| | Pro | Con | Offset | Unknown |
|---|---|---|---|---|
| Practical Reality | | | | |
| Basic Respect - | 1 protecting | | | |
| Self-Protection | 2A saves | | | |
| | 2B conserves | | | |
| Core Personal | | | | |
| Beliefs | | | | |
| Higher Order | | | | |
| Goals | | | | |
| Interaction | | | | |
| Commitments | | | | |
| Lower Order | | | | |
| Goals | | | | |
| Unknown | | | | |

### EXAMPLE 3

Paragraphs that mix Analysis and Support paragraphs together can be improved by division into two paragraphs, one with the decision issues and the other with only the deciding factors and support. For example, the paragraph:

“1 I plan to vote against the new River Dam. 2 The plan protects the environment. 3 It saves energy. 4 It also stops the damage of flooding. 5 However, we do not have the money.”

would have placements as shown in the following table:

| | Pro | Con | Offset | Unknown |
|---|---|---|---|---|
| Practical Reality | | 5 do not have | | |
| | | the money | | |
| Basic Respect - | 2 protects | | | |
| Self-Protection | 3 saves | | | |
| | 4 stops the | | | |
| | damage | | | |
| Core Personal | | | | |
| Beliefs | | | | |
| Higher Order | | | | |
| Goals | | | | |
| Interaction | | | | |
| Commitments | | | | |
| Lower Order | | | | |
| Goals | | | | |
| Unknown | | 1 against | | |

The paragraph forming the above table would be acceptable, but not superior by the system grading. It succeeds for focus because the table only shows one clear comparison and also provides evidence. The clear comparison is the limit of only one Pro level and one Con level. The evidence is multiple items in the paragraph in the same placement; that is, on the same Pro/Con side and priority level. However, the paragraph can be improved, because it is more difficult to understand due to the mixing of those two procedures and their order. The reader feels the weight of the evidence, but the conclusion is elsewhere. The communication would be better written by splitting the paragraph into one paragraph for evidence and one paragraph for comparison.

Further, if the decision is based upon the Con, the evidence is about a different level. The evidence does not support the decision as documented by the system from the communication. The system would recommend that support for items not at the higher, decision-driving level seems inappropriate. If the decision is negative, one example of a Pro is probably sufficient.

Further, the method also identifies that the Con might have an Offset that would also change the underlying decision. The Offset would balance the top level that drove the decision.

Finally, the method would also identify that the flow was from bottom to top. The decision driving communication element was the last item. This creates suspense. The method would summarize all the decision path choices for a document and determine if the suspense pattern was used more than standard levels.

From the above principles, the patterns of words placed into the Decision Matrix can be analyzed to generate respective commendations, comments or recommendations. In one embodiment, a 3×2×2 matrix representing 12 possible scenarios of patterns for commendations, comments or recommendations can be summarized as follows:

| Levels | Placements | 1 Side Only Used | Both Sides Used |
|---|---|---|---|
| 1 Level | 1 Placement | Scenario.1.Commendation | Scenario.11.Commendation |
| Only | >1 | Scenario.2.Commendation | Scenario.3.Comment |
| | Placement | | |
| 2 | 1 Placement | Scenario.11.Commendation | Scenario.4.Commendation |
| Levels | >1 | Scenario.12.Comment | Scenario.5.Comment |
| Only | Placement | | |
| >2 Levels | 1 Placement | Scenario.6.Comment | Scenario.8.Recommendation |
| | >1 Placement | Scenario.7.Comment | Scenario.9.Recommendation |

The pattern analysis performed in the Decision Matrix should not be limited to the pattern recognition scenarios set forth in the above table, where it is understood that the Decision Matrix can be utilized to recognize any number of possible scenarios depending upon the particular classifications utilized for the Decision Matrix.

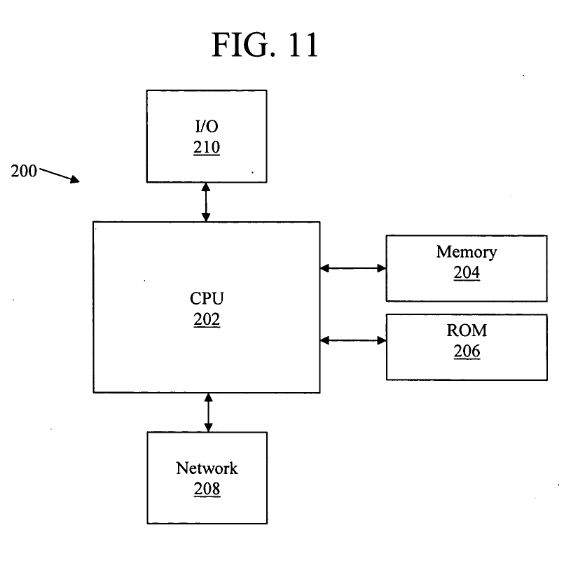

Referring now FIG. 11, an illustration of a general-purpose computer system 200 is provided which is suitable for implementing communications analysis in accordance with the present disclosure. The computer system 200 is only one example of a suitable computing environment and is not intended to suggest any limitation as to the scope of use or functionality of the invention. Neither should the computer system 200 be interpreted as having any dependency or requirement relating to any one or combination of components illustrated in the exemplary computer system 200.

In various embodiments, the present system and method for analyzing communications is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The present system and method for analyzing communications may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices. In one embodiment, the computer system 100 implements communications analysis by executing one or more computer programs. The computer programs are stored in a memory medium or storage medium such as the memory 204 and/or ROM 206, or they may be provided to the CPU 202 through the network 208 or I/O bus 210.

The computer system 200 includes at least one central processing unit (CPU) or processor 202. The CPU 202 is coupled to a memory 204 and a read-only memory (ROM) 206. The memory 204 is representative of various types of possible memory: for example, hard disk storage, floppy disk storage, removable disk storage, or random access memory (RAM). As shown in FIG. 11, typically the memory 204 permits two-way access: it is readable and writable. The ROM 206 is typically readable only. The memory 204 and/or ROM 206 may store instructions and/or data which implement all or part of the communications analysis system and method described in detail below, and the memory 204 and/or ROM 206 may be utilized to install the instructions and/or data.

The computer system 200 may further include a variety of additional computer readable media. Computer readable media can be any available media that can be accessed by the computer system 200 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer system 200. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of any of the above should also be included within the scope of computer readable media.

The CPU 202 may be coupled to a network 208, such as a local area network (LAN), wide area network (WAN), or the Internet. The CPU 202 may acquire instructions and/or data for implementing communications analysis transformation over the network 208. Through an input/output bus 210, the CPU 202 may also coupled to one or more input/output devices that may include, but are not limited to, data storage devices, video monitors or other displays, track balls, mice, keyboards, microphones, touch-sensitive displays, magnetic or paper tape readers, tablets, styluses, voice recognizers, handwriting recognizers, printers, plotters, scanners, satellite dishes and any other devices for input and/or output. The CPU 202 may acquire communications, instructions and/or data for implementing communications analysis through the input/output bus 210. It is further understood that the present method for analyzing communications may alternatively be implemented using non-computer-related methods and systems.

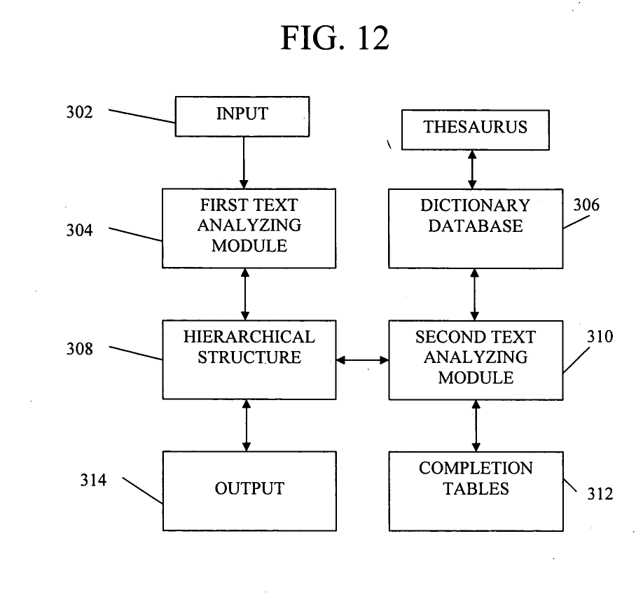

Referring now to FIG. 12, a block diagram of a system 300 for analyzing communications is illustrated. In one embodiment, the components of FIG. 12 are located within a personal computer system, such as the computer system 200 shown in FIG. 12. In other embodiments, the components are distributed across a distributed computing environment and connected together through network connections and protocols. For example, the components could be distributed across an intranet or the Internet. The components include program modules and data files stored on the computer system 200 for implementing the communications analysis method described herein.

The system 300 includes input communication 302 that is provided to the system 300 in machine readable form. Communications comprising digital files known to those skilled in the art are preferred. However, other communications are also contemplated by the present disclosure and the input communication 302 may further include devices for converting received communication into machine readable form, such as optical character recognition (OCR) devices, speech recognition devices and the like.

The system 300 includes a first text analyzing module 304 which parses or divides the received communication into communication elements, such as by performing natural divisions in the communication including but not limited to passage, paragraph, sentence and phrase division. Information gathered during the transformation process includes identifying the steps of the Process classification hierarchy, determining Value classification hierarchy identification, and determining View classification hierarchy identification. Information relevant to these classification hierarchy categories is often derived based on context. This information is not always able to be completely determined from the definitional information in the dictionary.

Thus, the first text analyzing module 304 also performs verb phrase division, performs subject identification and KADARF step identification or other identifications required for the particular classification hierarchies being employed. Information related to parts of speech may also be gathered by first text analyzer. Once the necessary communication element divisions and identifications have been performed, a dictionary database 306 containing classification hierarchy element is queried as previously described. When a match is determined in the dictionary database 306, the definition of a match is used to populate k-dimensional hierarchical structure 308 (or analysis array). The first text analyzing module 304 will also perform Value identification and prepare new View, Situation and/or Process identifiers for the received communication that are placed into the hierarchical structure 308. The first text analyzing module 304 will still further perform reference clause processing as previously described.

When multiple instances of the same word with different definitions occur in the dictionary, first text analyzer examines the classification hierarchy elements of nearby words until it excludes all but a single instance of the word. The definition of the single instance of the word is used to populate k-dimensional analysis array. The process of matching a word in the communication with a word in the dictionary occurs for all words in the communication.

In an embodiment, an instance of a word in the dictionary may have multiple definitions within the same classification hierarchy. Consequently, classification hierarchy definitions in the dictionary may be prioritized based on the importance of a given classification hierarchy definition. Thus, an addition to using the classification hierarchy definitions to populate k-dimensional analysis array, priority information may also be included in k-dimensional analysis array as extra information with which to analyze the data in k-dimensional analysis array.

A second text analyzing module 310 is utilized to further complete entries in the hierarchical structure 308. The second text analyzing module 310 will perform perspective, actor and recipient identification for the Parties and will also fill in missing items in the hierarchical structure 308 using relationships stored in completion tables 312 that are accessed. Such information may be information inherent within a given placement within a classification hierarchy dimension of k-dimensional analysis array. For example, in an embodiment the word ‘school’ is defined as a location in the Situation classification hierarchy. However, a sentence reads “I want to go to school,” the word ‘school’ is both a Location and a Goal under the Situation classification hierarchy framework. Conversely, the sentence “There is a school” does not imply the a goal of arriving at school. The completion table used in conjunction with second text analyzer populates the Goal category in the Situation classification hierarchy dimension of k-dimensional analysis array in the first instance, but not in the second instance.

Moreover, one embodiment uses completion tables 312 to populate k-dimensional hierarchical structure 308 with information implied in the communication. For example, a sentence may read “Let's go.” The context of the surrounding words in the sentence omit clues as to the identify of the speaker, the identity of the recipient of the communication, or the intended destination. It may match the “us” to specific parties. The completion table 312, in conjunction with second text analyzing module 310, directs population of k-dimensional array based on textual clues in other parts of the communication. Thus, the combination of completion tables 312 with the second text analyzing module 310 forms a powerful tool that populates the k-dimensional hierarchical structure 308 with information based on the communication and specific instructions how to populate k-dimensional hierarchical structure 308 in completion tables based on implied elements within a communication. An embodiment expressly contemplates omitting the second text analyzing module 310 by implementing the first text analyzing module 304 with the functionality of the second text analyzing module 310 as previously described.

The second text analyzing module 310 will further identify confusing, redundant and/or conflicting terms in the hierarchical structure 308 after populating additional items using the information retrieved from the completion tables 312. After the hierarchical structure 308 has been completed by the second text analyzing module 310, the hierarchical structure 308 is stored on any of the computer storage media. The hierarchical structure 308 is then utilized to generate a desired output 314. By using information in multiple dimensions, output related to various aspects of the communication is generated. Output may be generated by examination of ratios, orders, patterns, identification of duplicated information, evaluations of linearity in the flow of the ideas presented, tone of the communication, and depth of the proper usage of terms in the communication.

As an example of this principle, a communication comprises a single paragraph describing a boy's trip to the store to buy milk. Examination of the Situation classification hierarchy versus the Process classification hierarchy provides information relevant to the organizational flow of the paragraph. In this example, if information about the boy, his errand, and his deadline to accomplish the errand are presented after a discussion of the results of his errand, then the paragraph may be deemed to be disorganized and need rewriting or receive a reduced grade. By comparing data within classification hierarchies against data from other classification hierarchies, an automated procedure can be implemented to mechanically extrapolate meanings intended in the communication, which can be used to provide useful output.

One output may be an evaluation or grading of communication skills. Evaluations may be in the form of grades and grading values, outlines and summaries, recommendations, and other useful implementations as known to those skilled in the art. Because the present disclosure essentially derives the meaning of communications, it can also revise and rewrite the text mechanically while preserving the meanings of the original communication. Because the hierarchical structure contains information relevant to the ideas communicated in the original communication, the present disclosure can essentially reverse the steps to translate the communication into another language or another form of communication. One embodiment for accomplishing a translation substitutes one dictionary for another dictionary in a different language along with various algorithms for placements and transformation to and from that language. In an embodiment, the process of populating the k-dimensional analysis array is reversed. Fidelity of translation may be improved in this embodiment using a grammar algorithm to ensure the grammar of the translation.

Another embodiment may utilize the hierarchical structure as a more “sensitive” thesaurus. Because the present disclosure captures the meaning conveyed by the communication, recommendations for synonyms and antonyms can be suggested with greater precision and/or more useful information than those from a thesaurus that strictly relies on single words alone.

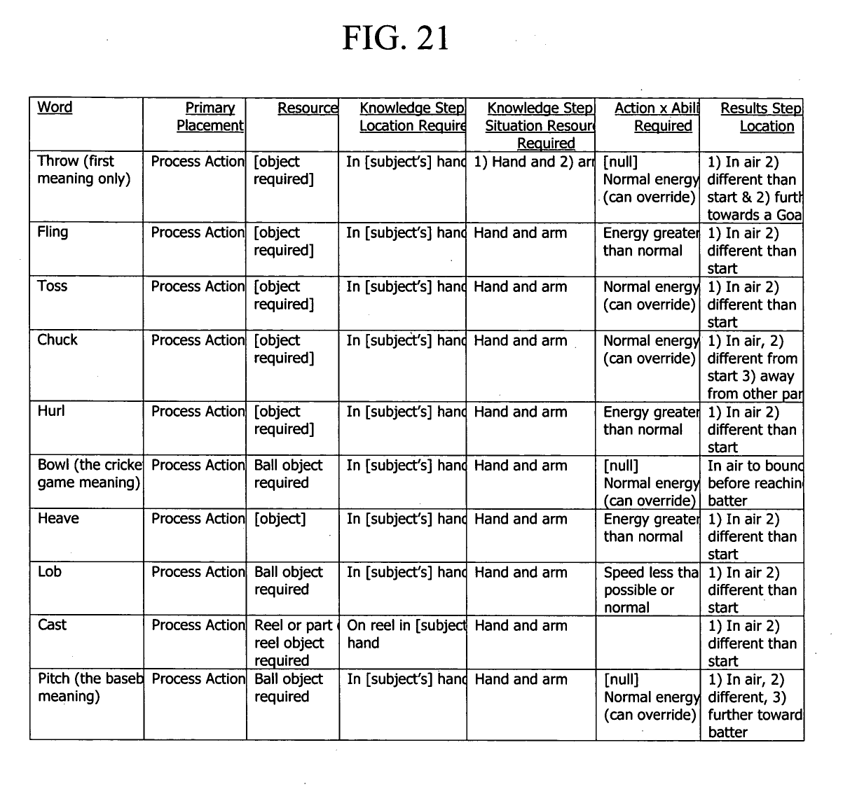

Conventional thesaurus and word search algorithms produce results that are simply a listing of words and do not have a closeness measurement. For example, a search for the first word “throw” using conventional thesaurus techniques would provide a list of words that are synonyms, such as “fling, toss, chuck, hurl, bowl, pitch, heave, lob, cast, confuse, puzzle, bewilder.” However, the dictionary database of the communications analyzer contain much more information associated with each stored word than simply a listing of other potentially synonymous words. Referring to FIG. 21, a hierarchical structure illustrating the components stored in the dictionary database for the word “throw,” for example, and for the other words in the list of synonyms is provided. The columns represent various boxes and placements of the k-dimension structure. In this example, they represent the Process Step (1-dimensional structure) or the Situation Resource x Process Results step (2-dimensional structure) or the View:Relative x Value:Positive x Process Action Step x Situation Energy (4-dimensional placement). Multi-dimensional structures having more than 2 dimensions are difficult to illustrate on a 2-dimensional picture, and are thus set forth as additional logic and words in the table box. However, the function in the boxes of the structure go beyond the words or phrases written in the boxes, such that they can further possess other functionality within the hierarchical structure.

As can be seen from the table in FIG. 21, the various definitions of the words have both similarity and difference in specific placements in the structure. The output table can be utilized by the communications analysis system to provide further user output that can prioritize those differences. For instance, the similarities and differences could be summarized as:

| Word | Elements (similarities/differences) |
|---|---|
| throw | 7 elements |
| toss | 7 matching elements, 0 extra |
| fling | 7 matching elements, 1 extra |
| chuck | 7 matching elements, 1 extra |
| hurl | 7 matching elements, 1 extra |
| heave | 7 matching elements, 1 extra |
| lob | 7 matching elements, 1 extra |
| bowl | 7 matching elements, 2 extra |
| pitch | 7 matching elements, 2 extra |
| cast | 7 matching elements, 3 extra |

One prior method to address closeness was adopted by George A. Miller and Christiane Fellbaum of Princeton's Cognitive Science Laboratory, which created a lexical database for the English language. The lexicon is a hierarchical database that has only one placement per word. By way of example, the word “cheat” in such a lexical database is a member of the subset of “wrong” which is a member of the subset of “interact” which is a subset of “act.” Thus, the word “act” is three steps away from the word “cheat” in the lexical database, whereupon a word in the “interact” subset, such as the word “meet,” would also be three steps away. The Princeton method presumes that all words create one specific meaning. The Princeton method differs substantially from the present disclosure in which various embodiments herein presume that all words are the combination of various elements. Embodiments in the present disclosure can measure words in terms of the closeness of various elements of the word that the Princeton method cannot measure.

For example, when assessing two student essays, the choice of words in the two different essay may yield different measurements. One essay might include the phrase, “he cheats his customers,” while another might include the phrase, “he failed to act very professionally.” Using the single-placement technique of the Princeton method, one would find “cheat” which is closely related to “swindle,” “bamboozle,” etc. The word “act” is six levels higher as the most general word relating thereto. The Princeton lexicon further shows the word “professional” in the subset of “adult” which is a subset of “human” and shows the word “fail” is also 3 steps from “act.” As such, the “fail to act professionally” would be at best three (3) steps away from “cheat” in the Princeton lexicon and the only connection would be they are both Actions.

Contrarily, in one of embodiment of the present disclosure, the word “professional” would have at least two elements—human and a value Basic Respect as a Pro—along with other elements about abilities/skills. The word “act” is about Action. “Cheat” would have multiple elements including Action and a Con to Basic Respect. In these senses, these two words would possess similarities, with both including an element about the same element Basic Respect. The analysis would also find that both words are about Actions of the same subject. The two verb phrases have two exact matches. The complete phrases look very similar as a complete placement using the multiple-placement format in one aspect of this invention. While the Princeton lexicon would identify the two sentences as not very closely related, the present embodiment of this disclosure would identify and provide grading and recommendations that would match these same two sentences as being closely related. Further, the present system would identify the elements of meaning with the words that create that closeness. Thus, the present system would lead to more robust solutions than the prior systems, such as the Princeton lexicon.

As such, the use of matching elements from within words in a hierarchy provides the invention with a unique method to identify passages that have corresponding plot flow, persuasive flow, logical flow, etc. Two passages written with different words can be identified as being similar using the multiple-placement element matching and closeness measures of the present disclosure. Furthermore, when this added functionality is linked to other aspects of the essay, the present system can provide even deeper understandings of the communications.

In this aspect, the present system and method provide a unique way to identify comparable portions of a passage from different writers. The essays can identify from very different words, writers and phrases to address the same issues and integrate those with other grading, recommendation and logical analysis. The system can show users how others can write differently while being built on the same elements.

Further, the communications analysis system might add a word to the list which has many matching elements but it also has conflicting elements. For instance, “fly” is an Action and ends in the air, but it will have a start location requirement “in the air” which is different than “in the hand” of “throw.” Thus, “fly” would have the following similarities and differences:

| | |
|---|---|
| fly | 6 matching elements, 3 extra, 1 conflicting element |

Alternatively, the output may include a more specific description of the different elements or more particularly by connecting elements into a concept and then concepts into words:

| | |
|---|---|
| Lob | adding the concepts “speed less than normal” |
| Cast | adding the concept “reel” |
| Pitch | adding element “toward batter” |

The concept phrase is one embodiment to show the linkage as a set or group of various elements. “Less than normal” is a combination of the Logical subdivision Relative and the Value Negative. “Speed” is an Energy Ability connected to Location Change Actions. Each of the capitalized words being members of the hierarchical structure.

By any measure, the use of the hierarchical structure in the communications analysis method and system provides more options and information regarding word relations than a conventional thesaurus. The present thesaurus capabilities capture the meaning conveyed by the communication and allow recommendations for synonyms and antonyms to be suggested with greater precision.

Output, in an embodiment, can be displayed to a user based on visual representations of information in k-dimensional hierarchical structure. Because the k-dimensional hierarchical structure is capable of storing data in greater than three dimensions, data may be represented as combinations of classification hierarchy tiers plotted against other classification hierarchy tiers. The output may be provided to an output device such as a computer screen, display, printer, email, a computer file, or other notification device or electronic storage medium as commonly known in the art.

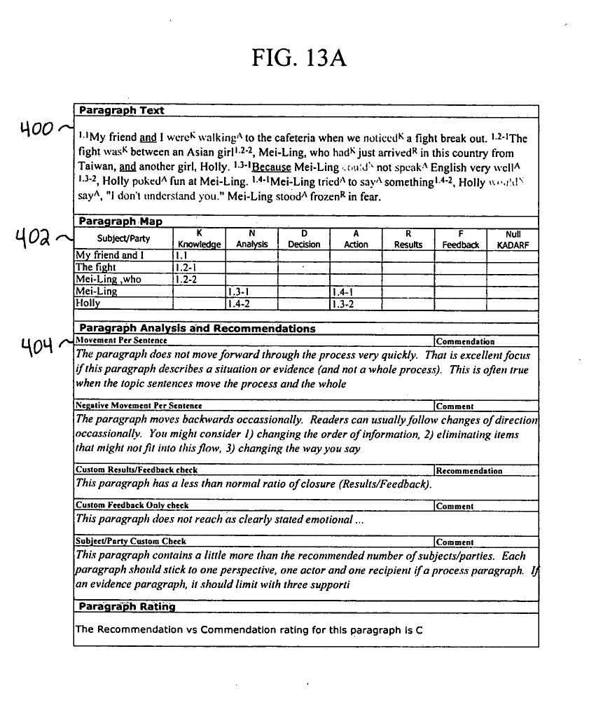

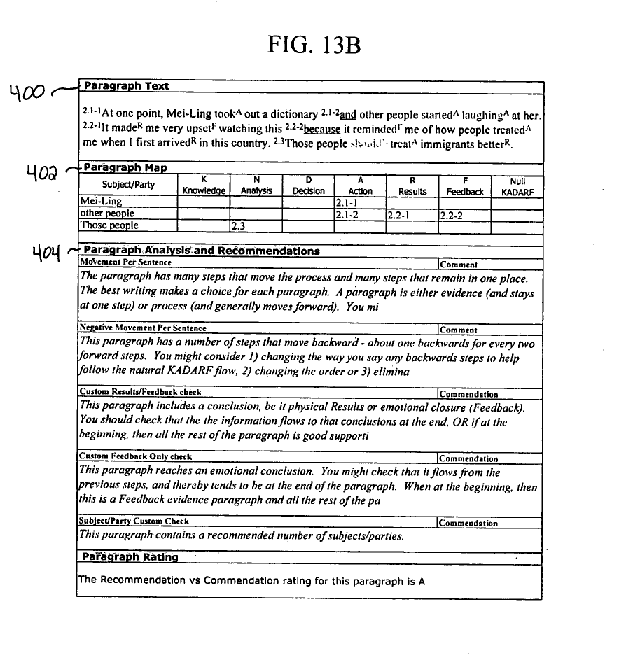

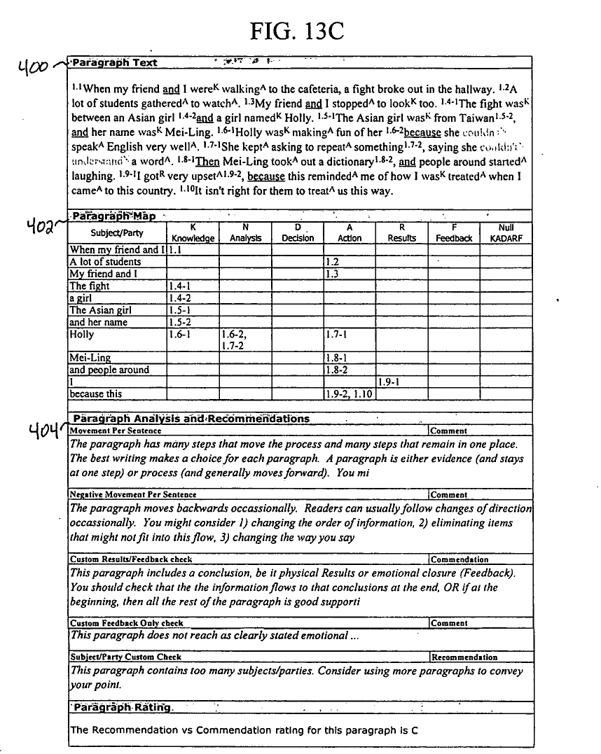

Referring now to FIGS. 13A-13C, a number of examples of output of the communications analysis performed in accordance the present disclosure are illustrated. In these example outputs, a paragraph text section 400 includes the communication being analyzed along with various identifications performed being indicated. The paragraph map 402 represents the Parties sub-classification in the Situation dimension versus the Process dimension of the hierarchical structure. The paragraph analysis and recommendations section 404 sets forth the analysis of the paragraph text using the information provided in the paragraph map 402.

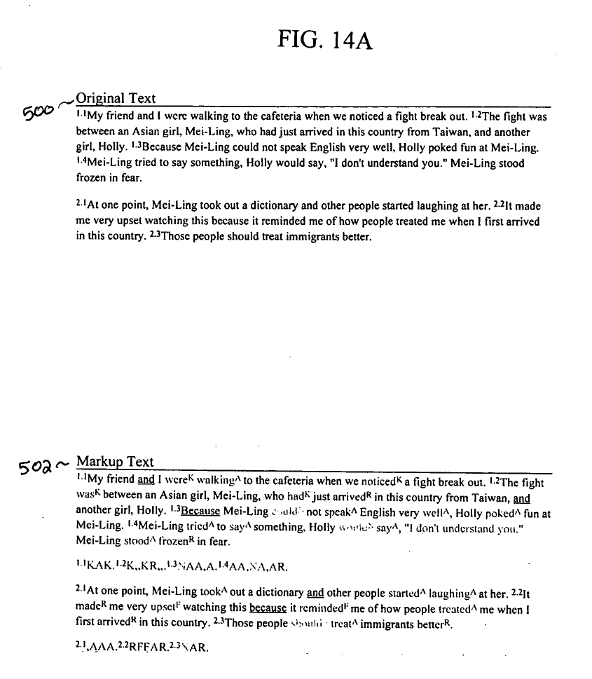

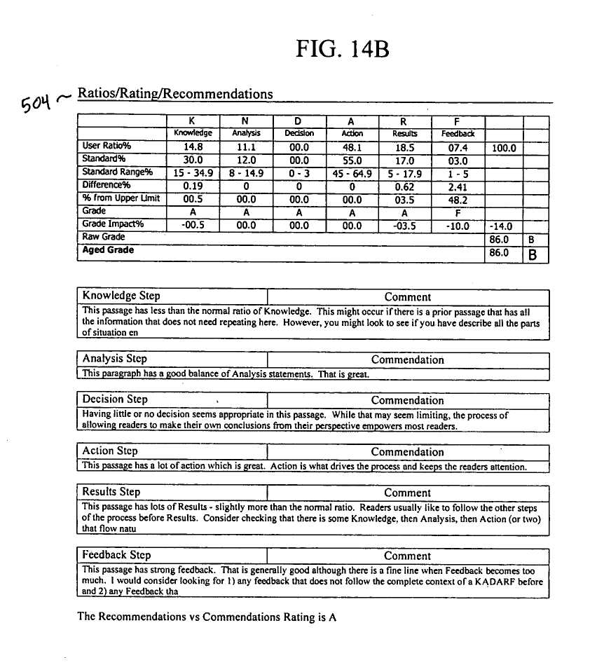

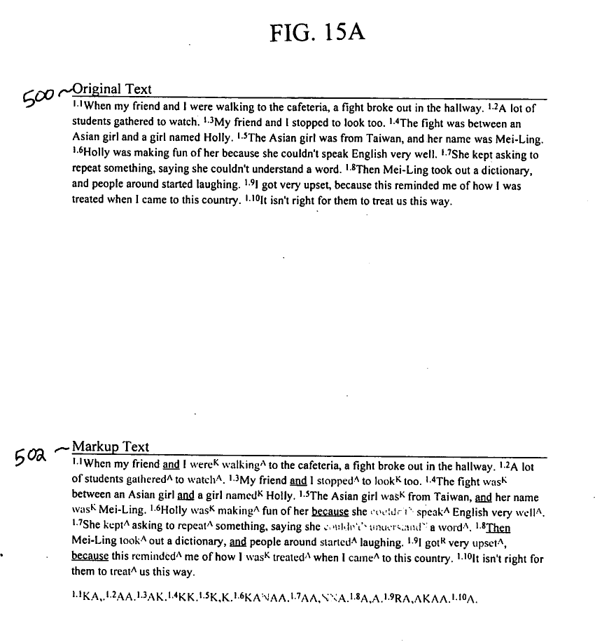

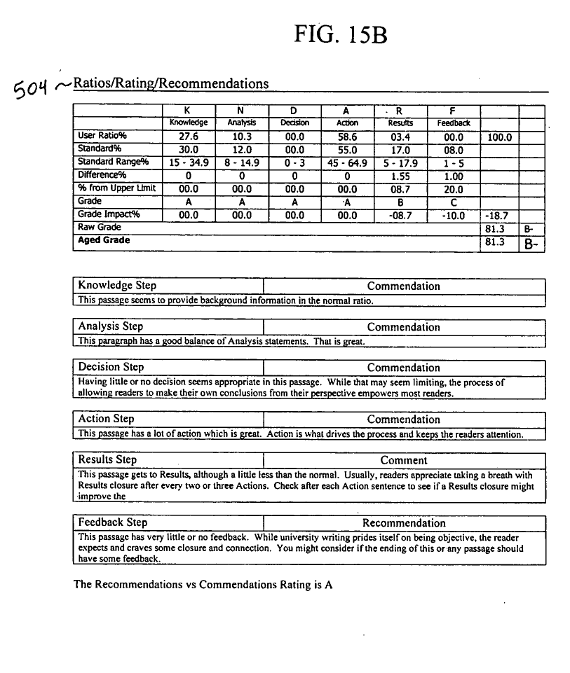

Referring now to FIGS. 14A-14B and 15A-15B, a number of examples of the output of communications analysis performed in accordance the present disclosure are illustrated. These examples illustrate the original text 500, the marked-up text 502 as broken down and identified in accordance with the text analyzing procedures described herein. The hierarchical structure section 504 represents the KADARF Process dimension of the text, where analysis of the information contained in the hierarchical structure is output there beneath.

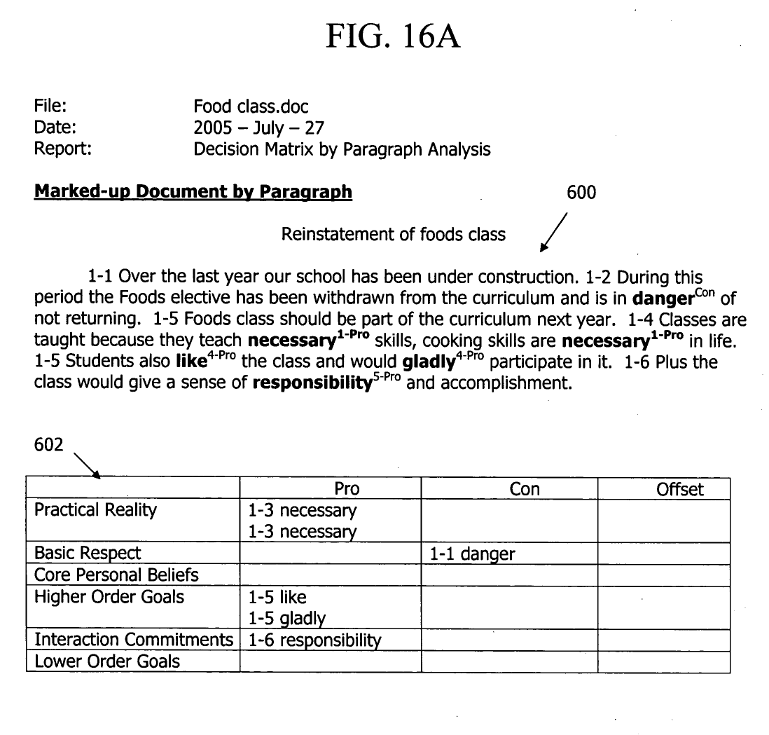

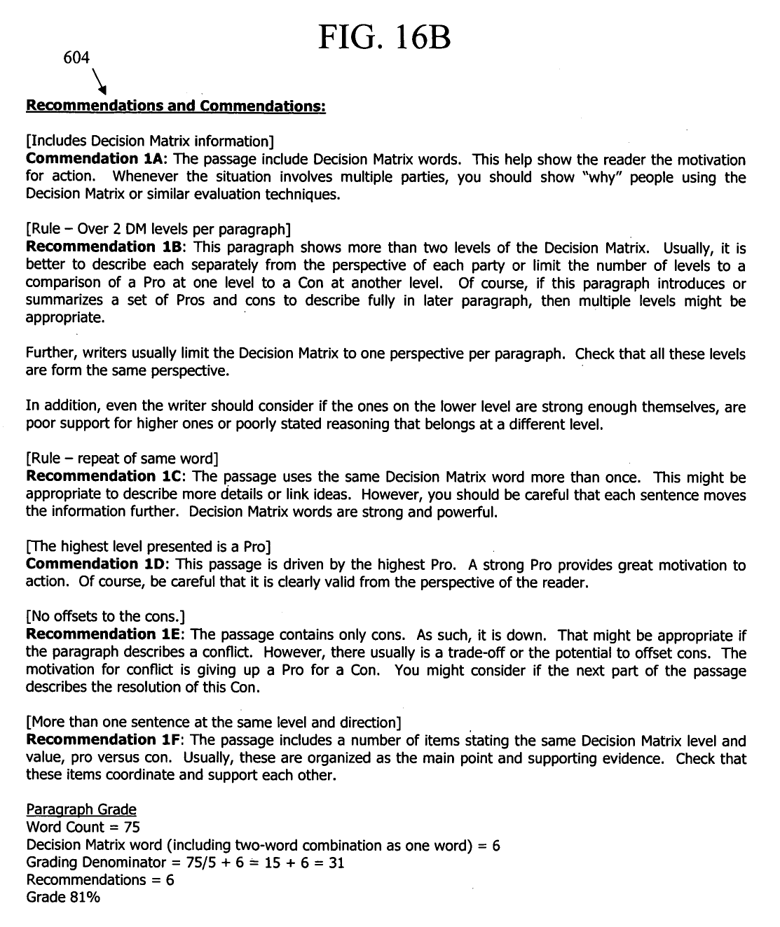

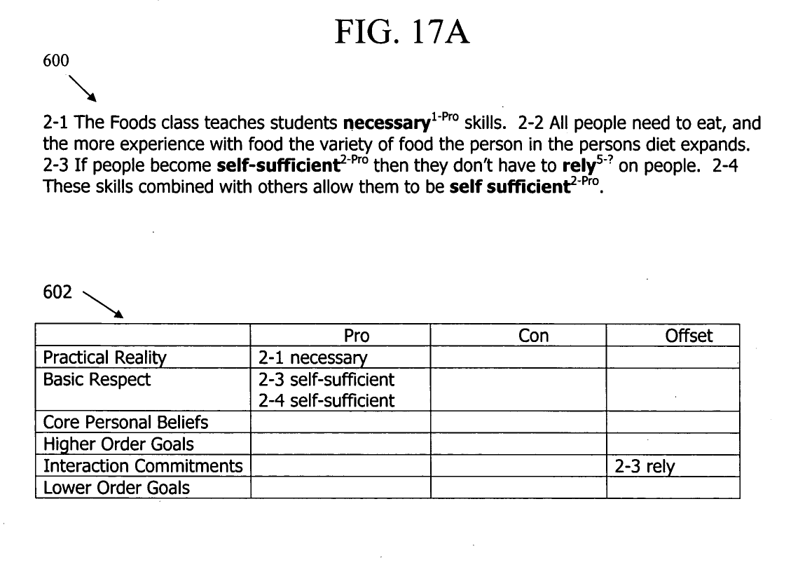

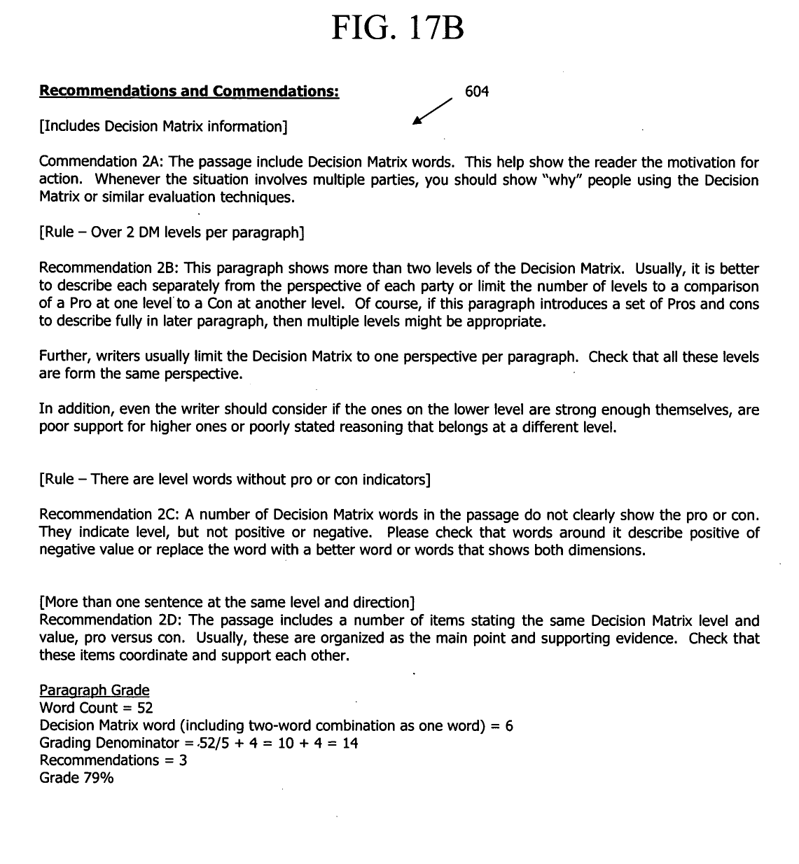

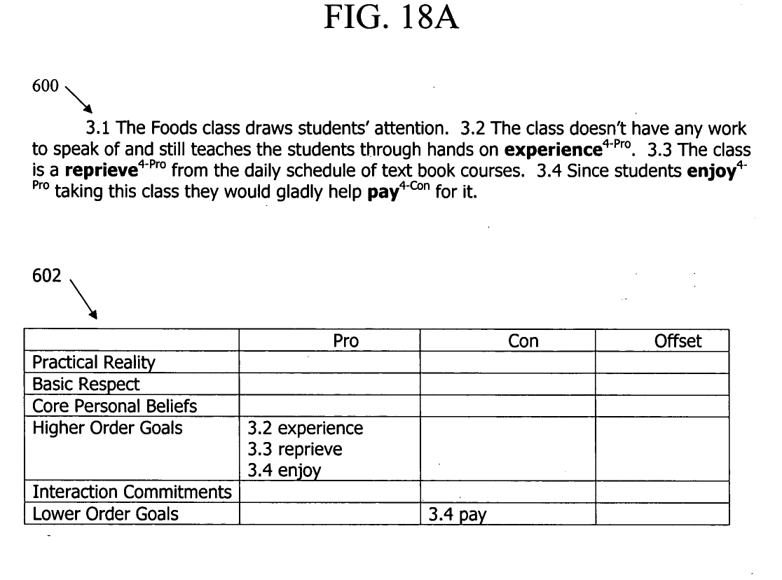

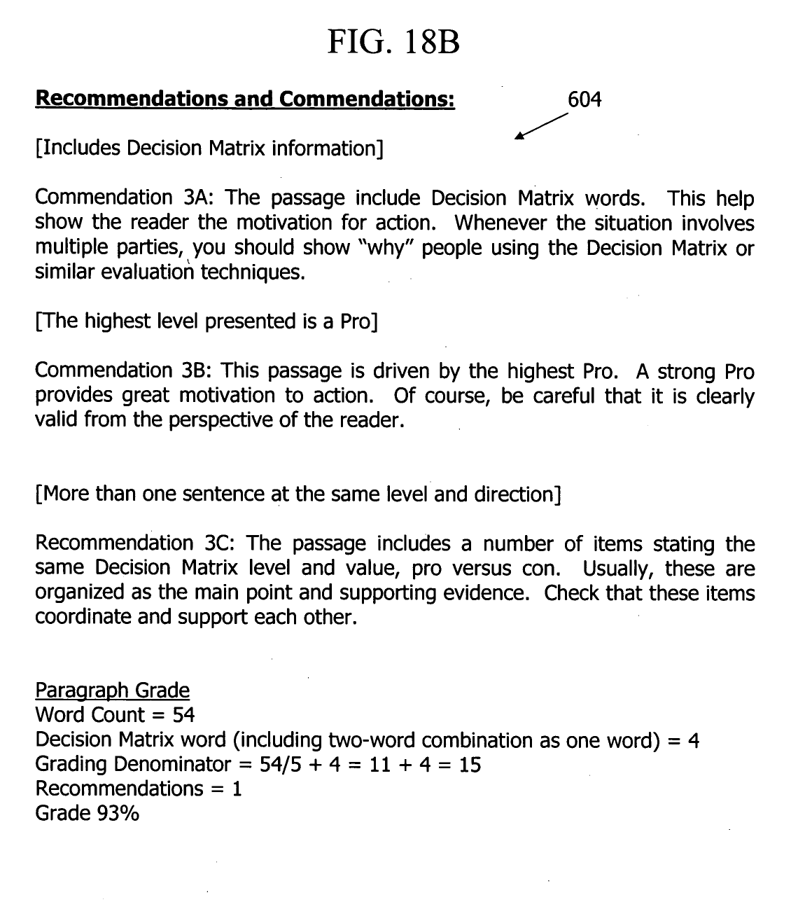

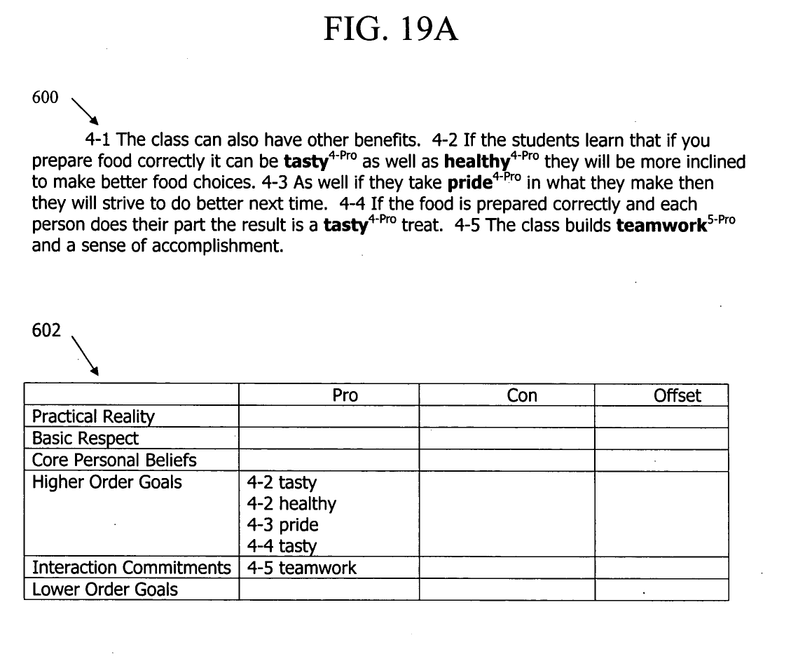

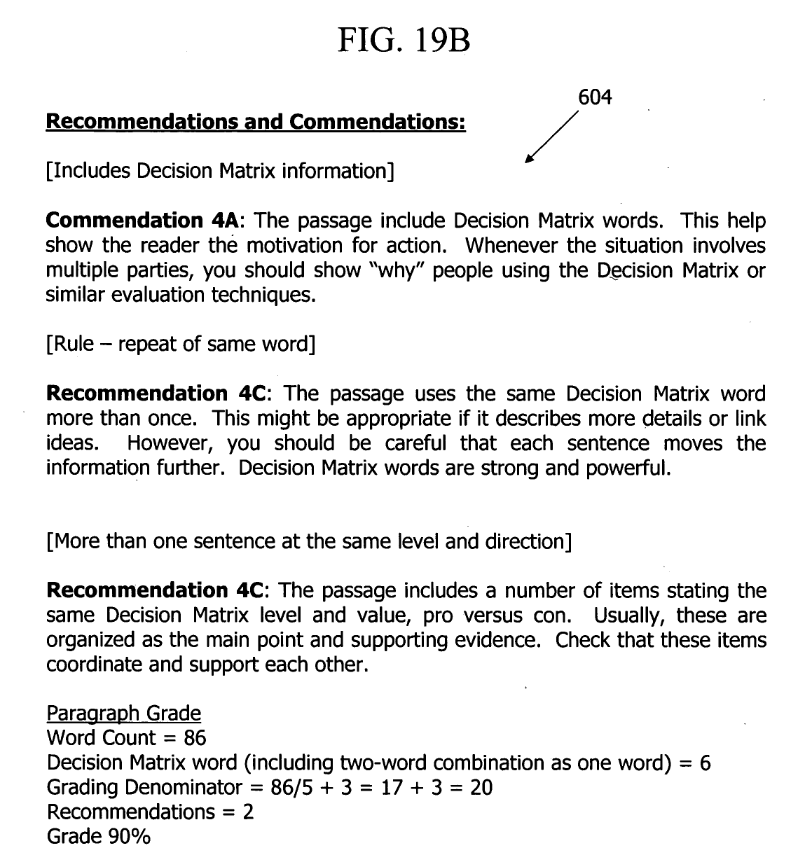

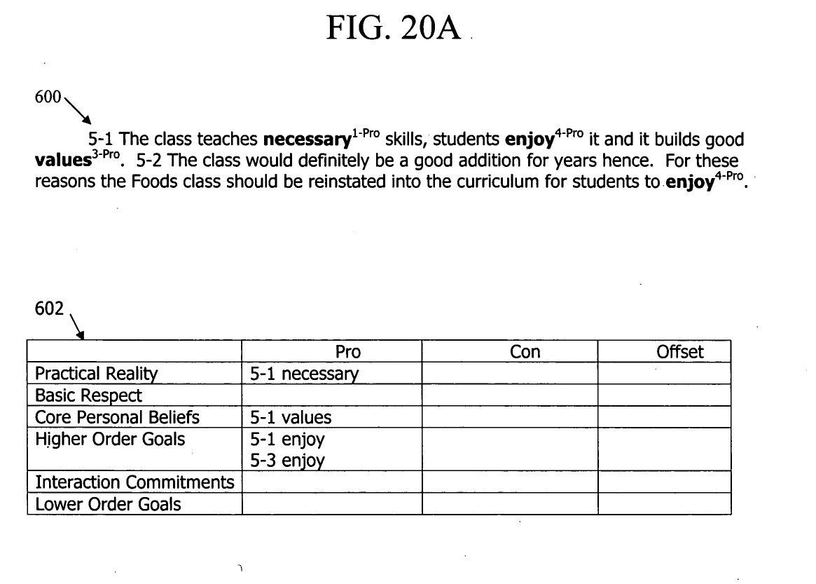

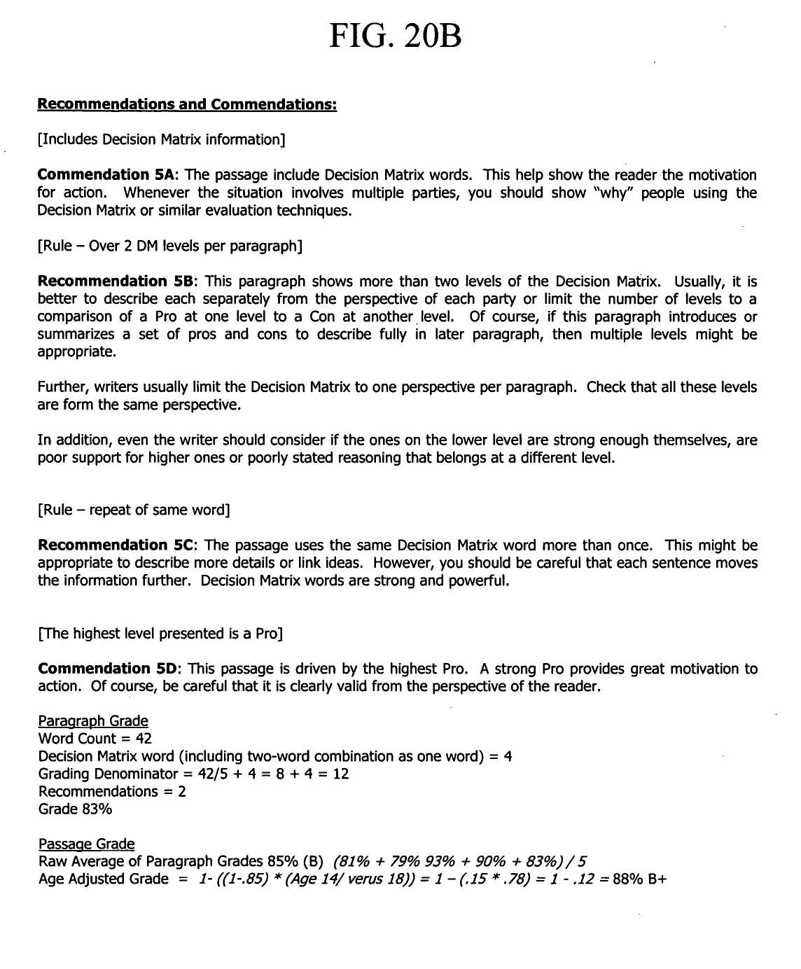

Referring now to FIGS. 16A-16B, 17A-17B, 18A-18B, 19A-19B and 20A-20B, a number of examples of the output of communications analysis performed utilizing the Decision Matrix in accordance the present disclosure are illustrated. These examples illustrate the marked-up text 600 as broken down and identified in accordance with the text analyzing procedures described herein. The hierarchical structure section 602 represents the Decision Matrix dimensions of the text, where recommendations, commendations and other analysis of the information contained in the hierarchical structure is output there beneath in section 604.

In one aspect, certain portions of the output of the communications analysis can be optionally selected by a user to reveal additional analysis of the communication. Such additional analysis may include a deeper analysis according to different levels of sub-classifications within the hierarchical structure or may otherwise include a different aspect of analysis. This enables the communication to be assessed on several different levels of the hierarchical structure that can lead to deeper levels of recommendations and grading adjustments that are not always readily visible at the broader, upper levels of the hierarchical structure.

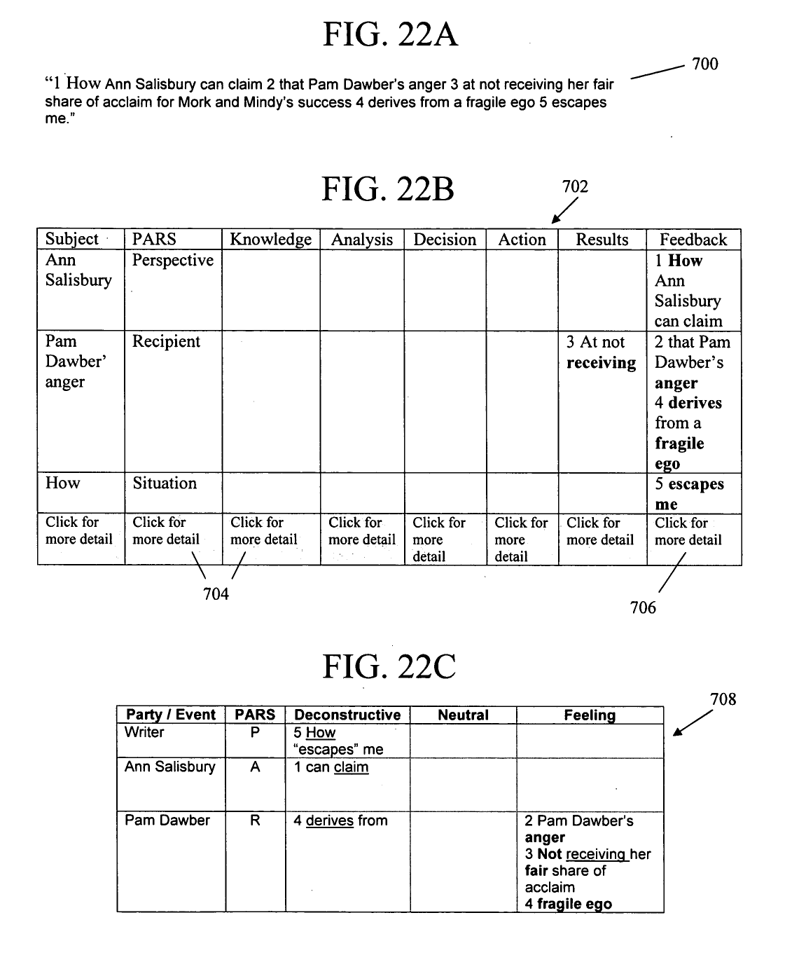

Referring to FIGS. 22A-22C, an example of an output for a communications analysis performed in accordance with one method of the present disclosure is illustrated, in which a portion of the hierarchical structure contains a reference or link to additional information regarding the analysis. This example illustrates marked-up text 700 in FIG. 22A as broken down and identified in accordance with the text analyzing procedures described herein. The hierarchical structure 702 in FIG. 22B represents the sub-classifications of the Parties classification in the Situation dimension versus the Process dimension in accordance with the present disclosure, where the PARS column in the structure 702 contains reference to either the Perspective, Recipient, Actor or Situation. In this example, the output is displayed on a computer screen or display to a user. As can be seen from the hierarchical structure 702, the majority of the placements from the text 700 are inserted into the Feedback column. The Feedback classification includes deconstructive and feeling/emotional sub-classifications, where a text passage typically should not be both. However, the hierarchical structure 702 shown in FIG. 22B does not provide a visual indication to the user regarding any information about the deconstructive and feeling/emotional sub-classifications.

The hierarchical structure 702 also includes a selectable portion 704 that contains a link or reference to additional or more detailed information regarding the analysis illustrated in the hierarchical structure 702. In one aspect, the selectable portion 704 may be activated by a user positioning a cursor over a “click for more detail” icon or other similar icon and selecting the selectable portion 704 (e.g., through use of a mouse, keyboard or other user-interactive device). After the selectable portion 704 is activated by a user, the user is provided with an output illustrating the corresponding additional or more detailed information. For example, by selecting icon 706 in the Feedback column of the hierarchical structure 702, an output such as the structure 708 illustrated in FIG. 22C would be provided to the user illustrating how the placements for the analyzed communication into the Feedback classification would be more precisely placed into the various sub-classifications for the Feedback classification, namely the Deconstructive, Neutral and Feeling sub-classifications. In this manner, more precise recommendations and grading evaluation calculations can be performed and illustrated to a user. For example, for the hierarchical structure illustrated in FIG. 22C where both Feeling and Deconstructive paths are present in the communication, a recommendation could be provided that readers do not usually follow both Feeling and Deconstructive paths and that incompatible Feedback subdivision methods may exist in the same communication passage.

By providing various outputs to a user that are based on respective levels of the hierarchical structure for the communication being analyzed, different levels of understanding of the communication can be expressed to the user and, in turn, different levels of analysis, recommendations and grading evaluations can be provided. This allows proficiency reports to be generated based upon summary placements for each classification, including sub-classifications, that provide deeper relationships, recommendation patterns and additional graphical representations of the results.

In another aspect, output reports can provide easily determinable feedback for analyzing communication by simply viewing patterns or progressions within the hierarchical structure. For instance, jumps or the lack of jumps through the hierarchical structure can provide a visual indication for analyzing the communication. This type of analysis is not possible with conventional graphic presentations of communication, such as word and grammar trees.

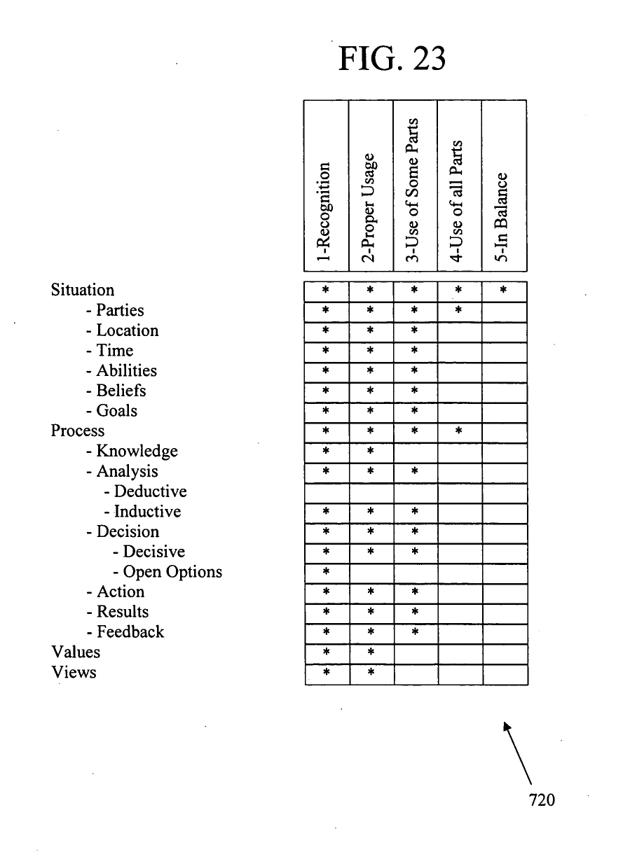

In one embodiment, the output displayed to a user can illustrate the depth of proper usage of communication elements in a communication being analyzed. Referring now to FIG. 23, an illustrative output report table 720 is shown which provides a visual representation of the depth of proper usage of communication elements in the analyzed communication as determined from placements of the communication elements in a multi-dimensional hierarchical structure. The depth of proper usage is illustrated in the various columns of the table 720 for the various classifications and sub-classifications of the dimensions of the hierarchical structure shown in the various rows of the table 720.

In one aspect, the depth of proper usage may be identified according to multiple different categories or levels of usage: 1) recognition, 2) proper usage, 3) use of some sub-classifications of a classification, 4) use of all sub-classifications of a classification, and 5) in balance. The “recognition” category identifies whether or not a particular classification or sub-classification exists in the communication. The “proper usage” category identifies whether communication elements, as placed into particular classifications or sub-classifications in the hierarchical structure, are being used properly in accordance with predefined rules (e.g., as set forth in the thesaurus, dictionary database, completion tables, etc.) or in accordance with the relationship of such placement within the hierarchical structure. The “use of some sub-classifications of a classification” category identifies whether at least one of the sub-classifications of particular classification category are represented in the hierarchical structure, while the “use of all sub-classifications of a classification” category identifies whether all of the sub-classifications of particular classification category are represented in the hierarchical structure. The “in balance” category identifies whether placements in a particular sub-classification or classification are in balance with placements in other sub-classifications or classifications in the hierarchical structure based upon desired ratios or relationships, where such desired ratios or relationships can be empirically determined from representative communications, from predetermined values or otherwise. The determination of whether or not placements are in balance can vary based upon the level of the communication being analyzed (e.g., an elementary school book report as compared to a college level thesis), where the desired ratios or relationships will vary accordingly. The determination of whether or not placements are in balance can also be instrumental in preparing commendations or recommendations for improvement.

The above-listed categories are but one example of the possible categories for determining the depth of proper usage, where it is the intention of the present inventor that the depth of proper usage can be determined or shown using any number of possible categories, including but not limited to the above-listed categories. These include comparison to standards, comparison to essays within a group, such as a partciluar prompt for a particular teacher and grade level or other comparative manipulations that are possible with the data so organized by the invention. In one aspect, the output presentation of the depth of proper usage using the hierarchical structures, such as shown in FIG. 23, is based upon placement of communication elements in the hierarchical structure and may include recommendations from other calculations, as described herein above. In the particular example illustrated in FIG. 23, asterisks “*” in the chart 720 indicate that a particular depth of usage has been achieved.

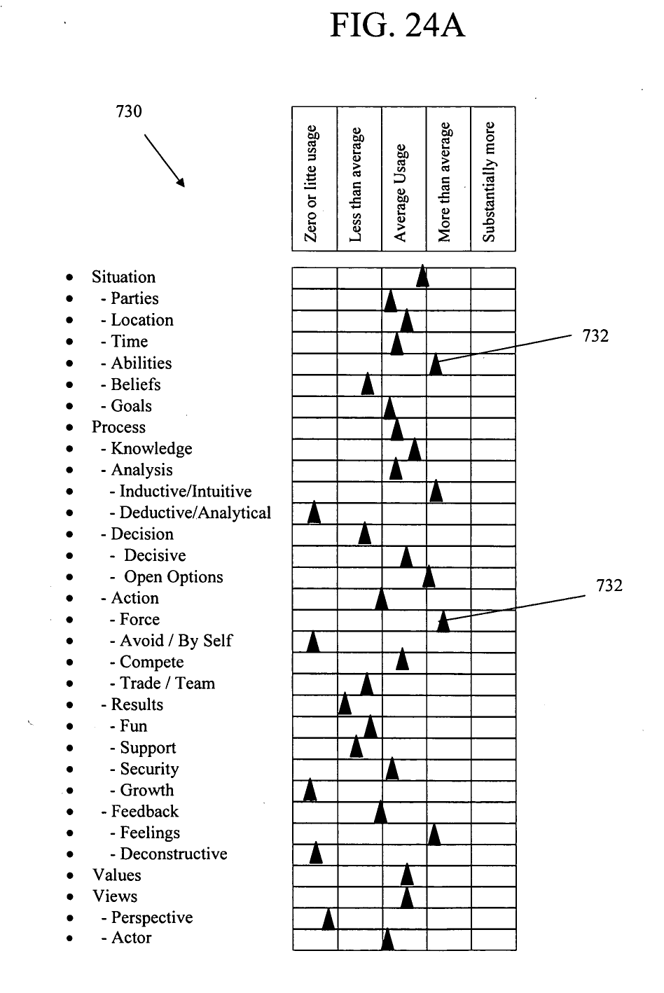

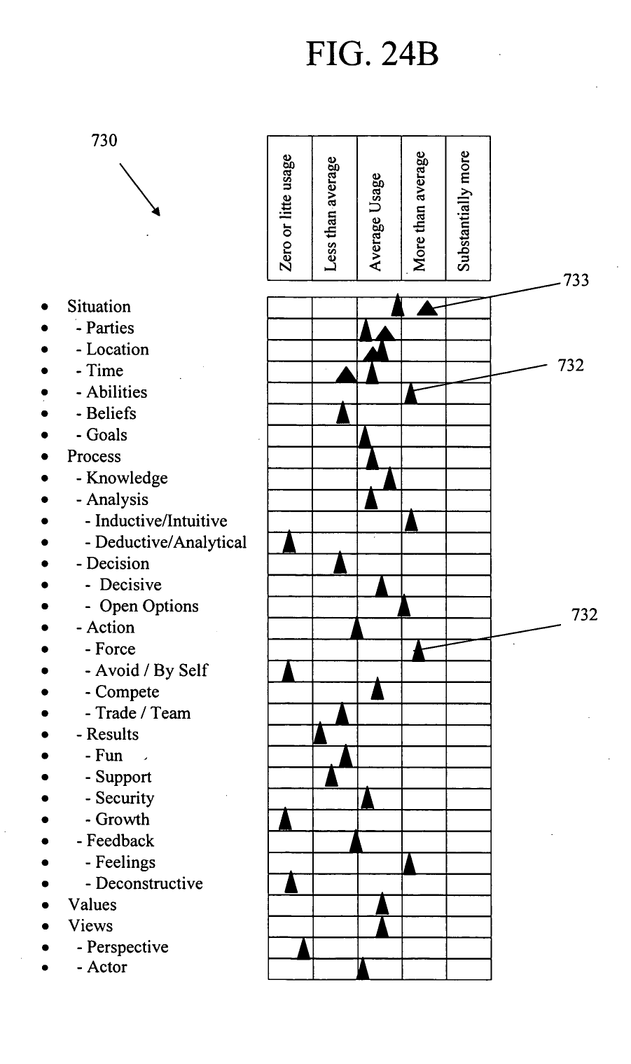

In another embodiment, the output displayed to a user can illustrate the tone of the communication being analyzed. The measurement of tone would be the selection of various elements and comparison in ratio, order, grouping and existence of different elements. For example, the tone in one embodiment might be described as 1) visual (from the ratio Knowledge step subdivsions), 2) inductive, 3) decisive, as wells a practical (from the Value Decision Matrix ratio of Practical Reality placements), where each of these can be scaled, reported, and/or graded. In one aspect, the tone of the communication can be illustrated by usage of particular communication elements as determined by 1) concepts in communication elements and/or 2) concepts by grammatical constructs. For the communication being analyzed, the tone of the communication can be determined from the hierarchical structure, such that information (e.g., character traits, etc.) is clearly linked to the hierarchical structure that has. conventionally been independent of communications analysis. The tone of the communication can be presented in an illustrative output by showing the usage of particular sub-classifications or classifications (based on their placement in the hierarchical structure) as such usage relates to a desired value or ratio for such sub-classifications or classifications in the communication. The desired values or ratios can vary based upon the level of the communication being analyzed (e.g., an elementary school book report as compared to a college level thesis), where the desired values or ratios can be derived from predefined standards or can be empirically determined from other communications. One example of an output to a user that illustrates the tone of a communication is shown in the table 730 in FIG. 24A, where the markers “A” 732 in the table 730 illustrate the degree of usage of a particular sub-classification or classification. In one aspect, the categories for the degree of usage may include: 1) zero or little usage, 2) less than average usage, 3) average usage, 4) more than average usage, and 5) substantially more than average usage. These are but a few possible categories of ratios for the degree of usage of a particular sub-classification or classification, where it is the intention of the present inventor that any number of possible categories and possible degrees of usage for such categories can be utilized, including but not limited to the above-listed categories.

In one aspect, the markers “▴” 732 in the table 730 can be interactive for a user, such that specific markers can be selected to yield additional information regarding their placement. Markers “▴” 732 appearing in “less than average” or “more than average” usage categories can have recommendations for improvement associated therewith that can be presented or output to a user if selected. In another aspect, the identification of markers “▴” 732 falling within specific categories over more than one analyzed communication can be monitored and used for additional analysis and/or recommendation. For example, referring to the illustrative example of FIG. 24A, the Deductive, Avoid/By Self, Growth and Deconstructive sub-classifications fall into the “zero or little usage” category. If that trend continues over a portfolio of communications that are analyzed, a problem in a communication style for a user can be identified and used to create specific areas for subsequent training or improvement.

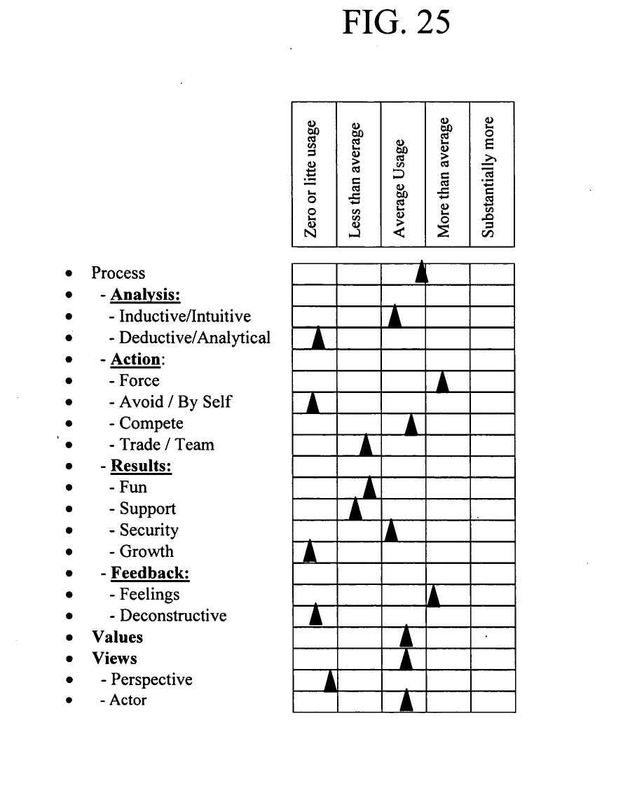

In another aspect, in order to simplify the scope of the output presenting an analyzed tone to the user, charts or tables having a reduced set of sub-classifications, classifications, and/or categories can be utilized. The particular sub-classifications, classifications, and categories can be variably selected for a desired output based upon the results that are intended to be displayed. For example, referring to FIG. 25, a table 740 is illustrated having a reduced number of sub-classifications and classifications from the table 730 illustrated in the example of FIG. 24A. Such simplified tables may alternatively only present specific sub-classifications, classifications, or categories or combinations thereof to a user, as desired.

Further, the inventor has found that various combinations of these tone elements relate to more grading, evaluation and recommendation aspects. For example, for certain writing, a Feedback step tone that is Emotional does not work as well with a Kinesthetic Knowledge step tone. It is not just the relative position of each of these tone elements, but their ratio and combination sets that define appropriate paths. The Kinesthetic approach, which can grade poorly in certain narrative essays as noted above, would work superior when connected to deconstructive Feedback in instruction manual writing. Therefore, secondary markers, as illustrated by the wider marker “▴ ” 733 in FIG. 24B can be compared to other markers which indicate the path of the highly graded essays or multiple paths with different symbols to write various combinations that create complete tones sets ranked as more effective.

From the foregoing it can be seen that the present disclosure provides a system and method which automatically evaluates and analyzes communications by comprehending the meaning of the communications to generate feedback that usually requires subjective grading by a human reader. A system and method is provided which processes communication into a useful multi-dimensional, hierarchical structure capable of: 1) providing a visual interpretation and analysis of the communication to illustrate patterns in visual results, 2) allowing further processes to performed on the hierarchical structure to identify errors in the communication, 3) providing an analysis of the communication, such as grading of the communication and recommendations for improvement, and 4) allowing for the automated creation of a new communication in any form and in any language by performing transformations of the hierarchical structure in reverse.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method of analyzing communication comprising:
receiving a communication including at least one communication element;
transforming the communication into a hierarchical structure corresponding to the communication elements, wherein the hierarchical structure is formed to be a multi-dimensional where each dimension consists of classification information relevant to at least one of organization, meaning, reference, and understanding of the communication, wherein at least one dimension includes classification information that can be divided into categories of sub-classifications such that communication elements in the communication are transformed into corresponding classification information and sub-classifications in the hierarchical structure;
analyzing the hierarchical structure to generate an output based on the received communication.

2. The method of claim 1, wherein at least one category of sub-classifications can be divided into additional categories of sub-classifications.

3. The method of claim 2, wherein each of the divided categories of sub-classifications comprise one level within the multi-dimensional hierarchical structure such that a plurality of levels are provided within the hierarchical structure by respectively dividing certain categories of sub-classifications into yet further categories of sub-classifications.

4. The method of claim 1, wherein the generated output provides an indication of a tone in the received communication based upon the analysis of the communication elements present in the hierarchical structure.

5. The method of claim 1, wherein the generated output provides an indication of a depth of proper usage of communication elements in the received communication based upon the analysis of the communication elements present in the hierarchical structure

6. The method of claim 1, further comprising:
providing a process dimension in the hierarchical structure that includes classification information related to process criteria,
wherein the process dimension of the hierarchical structure includes an analysis sub-classification category, and
wherein the analysis sub-classification category is divided to further include a criteria-based sub-classification category and an assessment-based sub-classification category.

7. The method of claim 1, further comprising:
providing a process dimension in the hierarchical structure that includes classification information related to process criteria,
wherein the process dimension of the hierarchical structure includes a decision sub-classification category, and
wherein the decision sub-classification category is divided to further include a decisive sub-classification category and an open options sub-classification category.

8. A method of analyzing communication comprising:
receiving a communication including at least one communication element;
transforming the communication into a hierarchical structure corresponding to the communication elements; and
analyzing the hierarchical structure to generate an output that provides an indication of a tone in the received communication.
